(19) United States
(12) Patent Application Publication
(10) Pub. No.: US 2014/0222658 A1
(43) Pub. Date: Aug. 7, 2014

(54) SYSTEM AND METHOD FOR MANAGING MORTGAGE LIFECYCLES

(71) Applicant: OmTelligence, LLC, Chicago, IL (US)

(72) Inventor: Mark A. Pickett, Bolingbrook, IL (US)

(73) Assignee: OmTelligence, LLC, Chicago, IL (US)

(21) Appl. No.: 14/245,143

(22) Filed: Apr. 4, 2014

Related U.S. Application Data
(63) Continuation of application No. 13/096,639, filed on Apr. 28, 2011, now abandoned.
(60) Provisional application No. 61/328,801, filed on Apr. 28, 2010.

(51) Int. Cl. G06Q 40/02

(52) U.S. Cl. CPC G06Q 40/025
USPC 705/38

(57) ABSTRACT

A method, a system and a computer program are provided for creating unprecedented transparency in mortgage markets. The system includes a fully integrated, web-based exchange platform that provides lenders, buyers, securitization participants and regulators all access to real-time reporting of housing market data. System technology stores and analyzes data on consumer profiles, approved and denied mortgage applications, appraisals and vendors, and any services they provide to any mortgage application. The data can then be used by regulators for forensic and predictive analysis that will support their ability to better manage fraud and predatory lending practices or any other aspect of the mortgage lending process. It will also enable better purchasing decision-making for home buyers. The system technology has the ability to drive system-wide accountability.

### CROSS REFERENCE TO PRIOR APPLICATIONS

This application claims priority and the benefit thereof from U.S. Provisional Application No. 61/328,801, filed on Apr. 28, 2010, and titled “System and Method for Managing Mortgage Lifecycles,” the entirety of which is hereby incorporated herein by reference.

### BACKGROUND OF THE DISCLOSURE

1. Field of the Disclosure

This disclosure is directed to a novel method, system, and computer program for managing mortgage lifecycles.

2. Related Art

The real estate industry and the housing finance system are vital to our economic recovery and our long term economic stability. Consistent with the importance of both of these systems, a few of Treasury Secretary Geithner's comments during his recent testimony capture the present scenario, “structural problems in the mortgage finance market have been building for decades . . . and have now created a clear need for reform.” Importantly, no matter what specific changes take place in the housing finance system, the make-up of the government-sponsored enterprises (GSEs), regulatory bodies or with regulation itself, transparency and real-time data access will be required in order to improve the risk assessment, risk management, and the accountability that must be present to ensure the success of any new system.

The present disclosure provides a novel method, system, and computer program for creating open and transparent markets in both the origination and securitization markets, and assisting in the process of creating mortgage market stability via transparency and accountability.

### SUMMARY OF THE DISCLOSURE

According to an aspect of the disclosure, a method, a system and a computer program are provided for creating unprecedented transparency in mortgage markets. The disclosure includes a fully integrated, web-based exchange platform that provides lenders, buyers, investment bankers, securitization participants and regulators all access to real-time reporting of housing market data. The system stores and analyzes data on consumer profiles, approved and denied mortgage applications, appraisals and vendors, and any services they provide to any mortgage application. The data can then be analyzed using forensic and predictive analysis that will enable better identification and management of fraud and predatory lending practices, as well other aspects of the mortgage lending process. The system enables better purchasing decision-making for home buyers. The system has the ability to drive system-wide accountability.

The disclosure provides a method and a system wherein the full lifecycle (from origination activities through securitization and beyond) can be managed from a unified data store, without disconnects between mortgages, securities, and the like. The users searching for mortgages are instantly available for querying/mining by lenders. The mortgages (and borrowers) are instantly available for examination by i-bankers, securitizers, and the like, and all information in the data store is visible to regulators. The method and system provide for the post-closing state monitoring or monitoring/assessing status or history of a mortgage that's being tracked for the benefit of lenders, investors, 3rd party ancillary service providers, and the like, in order to offer products/services to the consumer.

According to a further aspect of the disclosure, the method and system facilitate market making, for mortgages and otherwise, pooling and securitization (and the inspection of the underlying mortgages, before and after securitization), as well as fractionalization of a mortgage note.

A method is disclosed for managing a mortgage lifecycle, the method comprises: receiving user search criteria from a user for a loan program; searching all loan programs stored in a data store; determining an optimal loan program based on the user search criteria; presenting a loan application for the optimal loan program to the user; and creating a user profile based on the user search criteria and the loan application. The method may further comprise: storing the user profile in the data store; receiving supporting documentation from the user for the optimal loan program; managing the supporting documentation to support the loan application for the optimal loan program; rendering the user profile searchable by a lender, an investor, or a bank. The user search criteria may be received from a loan officer or a realtor; and/or facilitating management of a full lifecycle of a loan associated with the optimal loan program, including substantially all origination activities, substantially all securitization activities, and substantially all closing activities.

The user search criteria may include: an interest rate; a loan term; a loan amount; or a loan type. The method may further comprise: providing post-closing state monitoring information, monitoring/assessing status information or mortgage history information to another user; and facilitating market making for said another user for mortgages, including: mortgage pooling, mortgage securitization, or fractionalization of a mortgage note.

A mortgage lifecycle management system is disclosed, comprising: a loan origination system that is configured to receive a plurality of lender profiles, each of which includes one or more loan programs; a data store communicatively coupled with the loan origination system, the data store being configured to store the plurality of lender profiles; and a decision engine that is adapted to communicate with the data store to access the plurality of lender profiles, wherein the decision engine is further adapted to determine an optimal loan program on a basis of a user search criteria received from a user and the plurality of lender profiles. The system may further comprise: a communicator adapted to send a loan application to the user for the optimal loan program; a communicator that is adapted to receive supporting documentation from the user for the optimal loan program; a manager adapted to manage the supporting documentation to support the loan application for the optimal loan program, including all closing documents and records associated with the loan application; and/or a workflow manager adapted to manage at least one of a checklist, a condition to close, a communication message, an insurance rider, a title commitment, a sales contract, and an appraisal. The decision engine may be further adapted to: create a user profile based on the user search criteria and the loan application; index the plurality of loan programs; store the user profile in the data store. The user search criteria may comprise: an interest rate; a loan term; a loan amount; or a loan type. The system may further comprise a manager that: provides post-closing state monitoring information, monitoring/assessing status information or mortgage history information to another user, wherein said manager is further configured to facilitate market making for said another user for mortgages, including: mortgage pooling, mortgage securitization, or fractionalization of a mortgage note; facilitates management of a full lifecycle of a loan associated with the optimal loan program, including substantially all origination activities, substantially all securitization activities, and substantially all closing activities; and/or renders a mortgage that is associated with the loan application available to another user for examination.

A computer readable medium is disclosed having a tangibly embodied computer program thereon, which when executed on a computer cause the computer to carry out a method comprising: receiving user search criteria from a user for a loan program; searching all loan programs stored in a data store; determining an optimal loan program based on the user search criteria; presenting a loan application for the optimal loan program to the user; and creating a user profile based on the user search criteria and the loan application. The computer readable medium may comprise: a documentation receiving code section to receive supporting documentation from the user for the optimal loan program; a supporting documentation managing code section manage supporting documentation to support a loan application for the optimal loan program; a comparing code section to compare the user search criteria to all of the lender profiles; and/or a sending code section to send a loan application for the optimal loan program to a user device.

Additional features, advantages, and embodiments of the disclosure may be set forth or apparent from consideration of the following detailed description and drawings. Moreover, it is to be understood that both the foregoing summary of the disclosure, the following detailed description and drawings are exemplary and intended to provide further explanation without limiting the scope of the disclosure.

### BRIEF DESCRIPTION OF THE EXHIBITS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the exhibits:

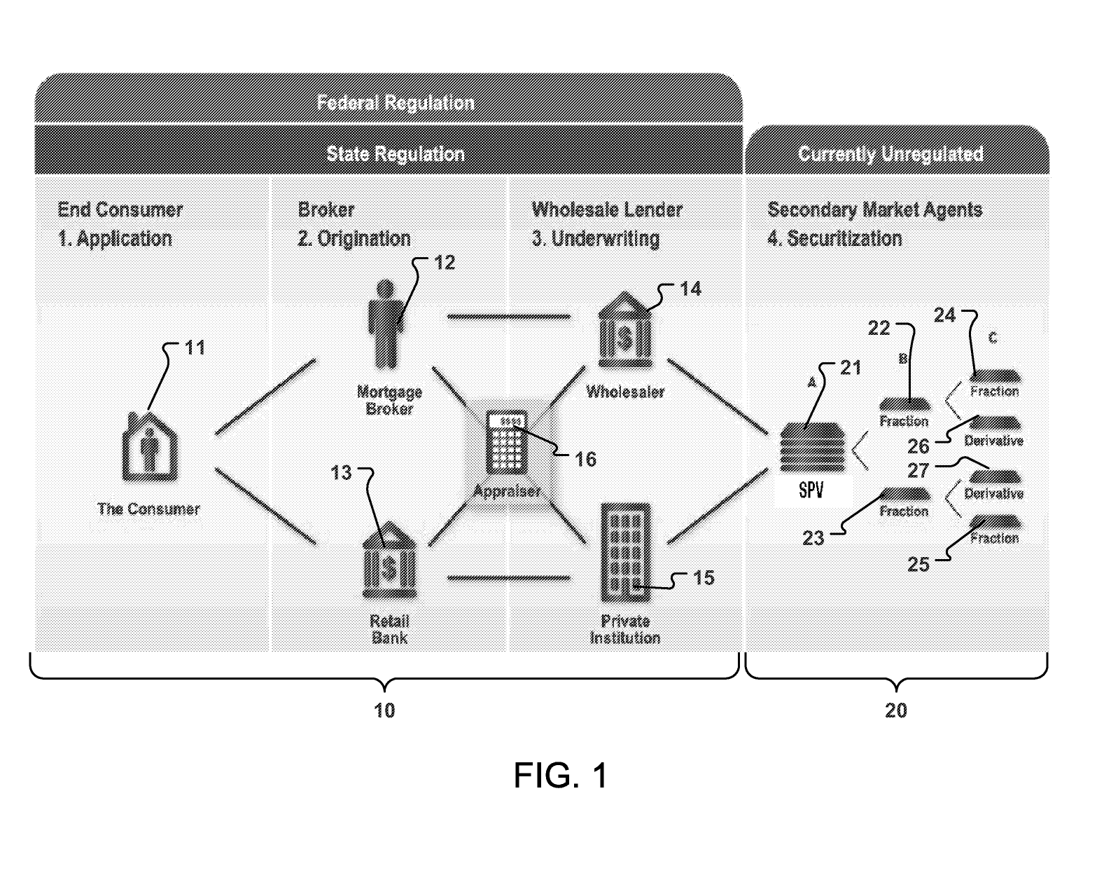

FIG. 1 illustrates an example of a traditional mortgage lifecycle that consists of a regulated portion and an unregulated portion;

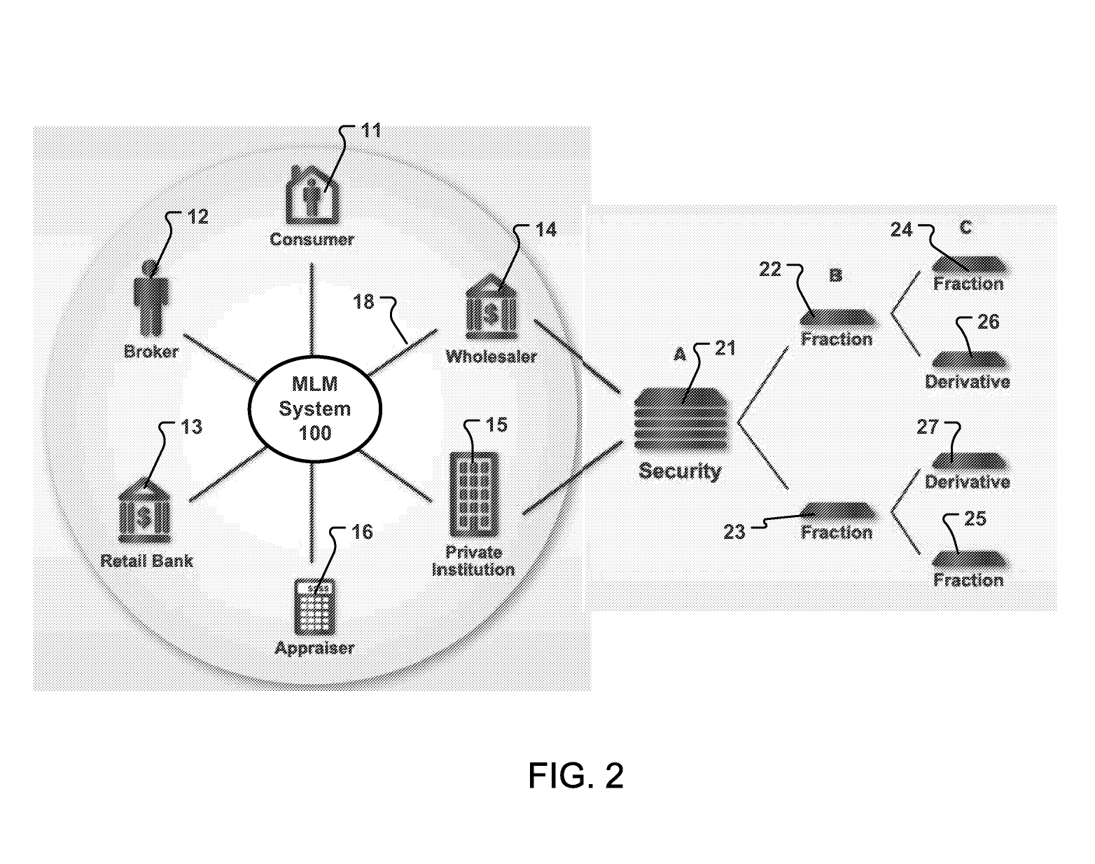

FIG. 2 illustrates an example of a mortgage lifecycle management (MLM) system, constructed according to principles of the disclosure;

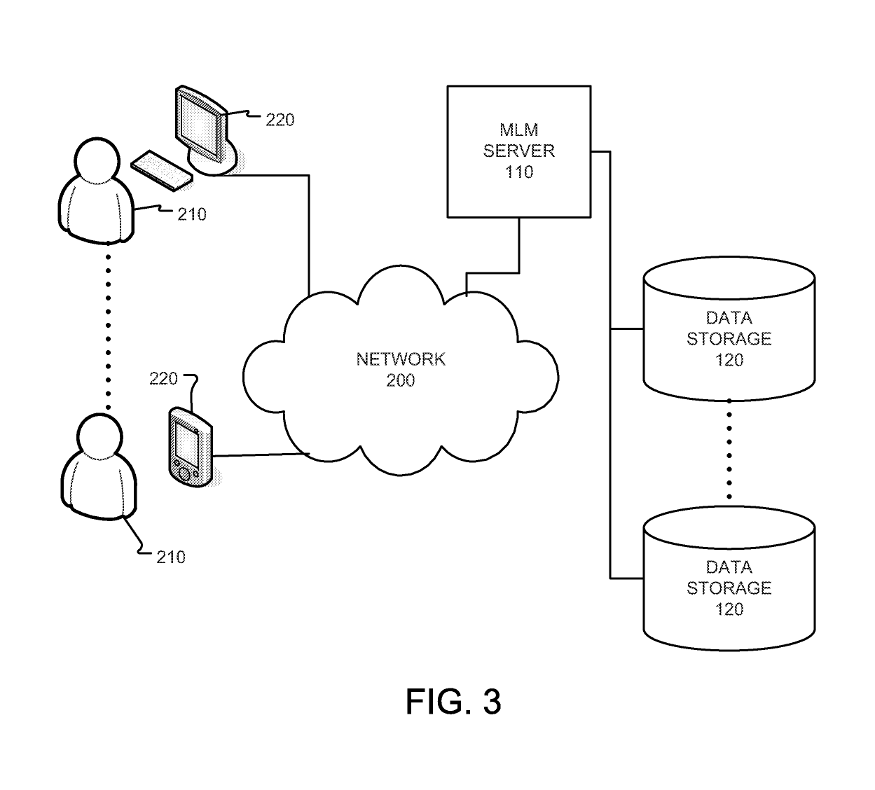

FIG. 3 shows a further aspect of the MLM system of FIG. 2;

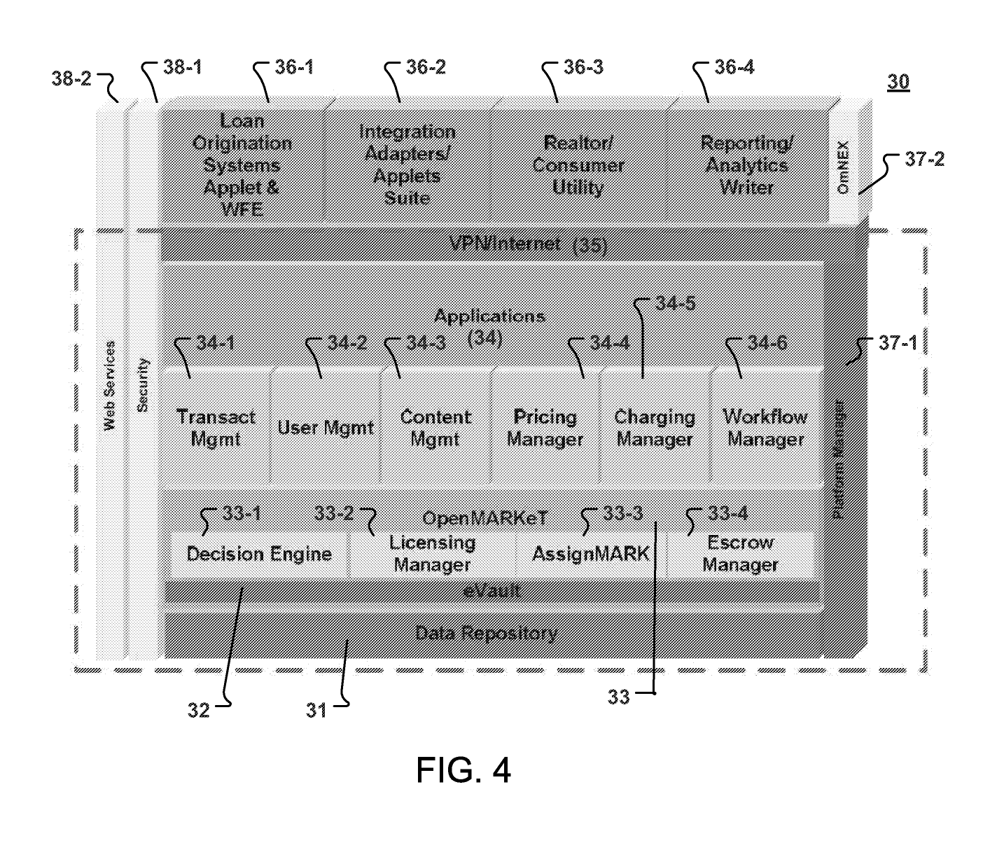

FIG. 4 shows an example of a suite of highly scalable and component neutral (HSCN) applications that are built upon an access-agnostic platform, which may be included in the MLM system of FIG. 2;

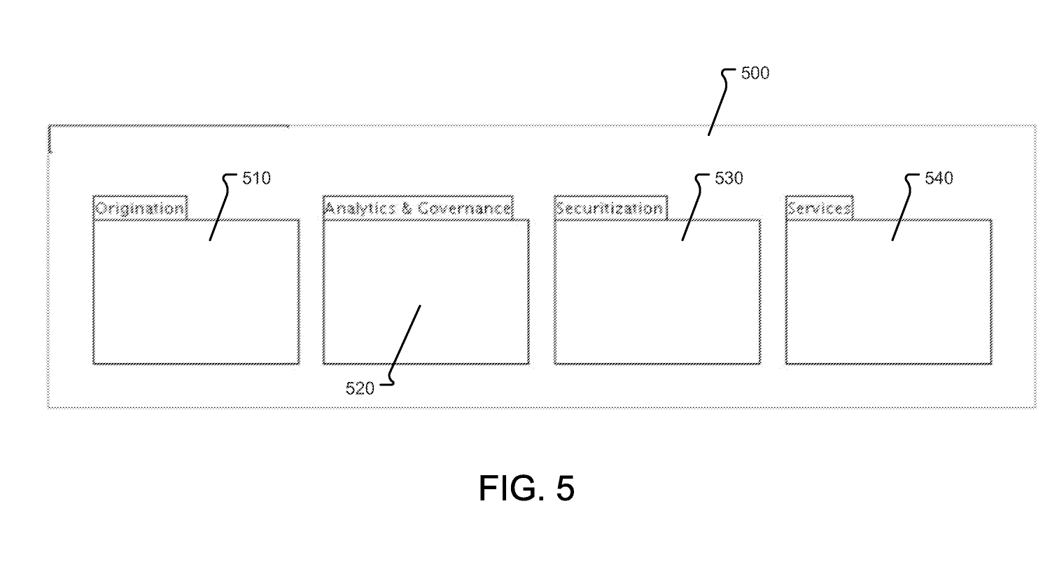

FIG. 5 shows an example of a display screen that displays four different examples of suite tools;

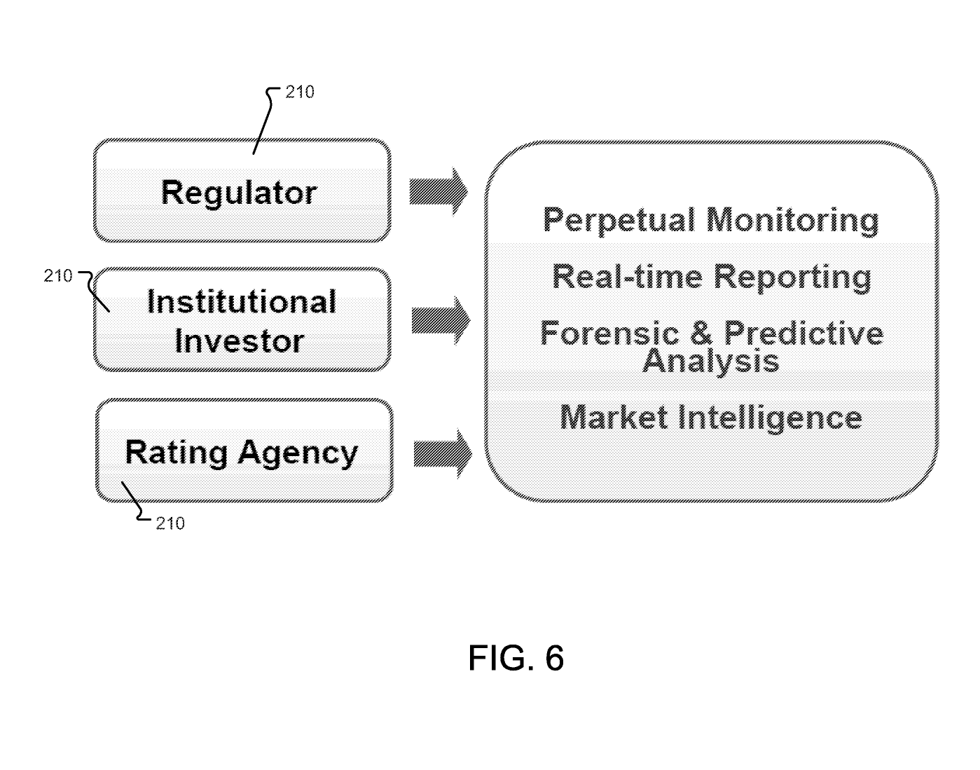

FIG. 6 shows a market intelligence diagram;

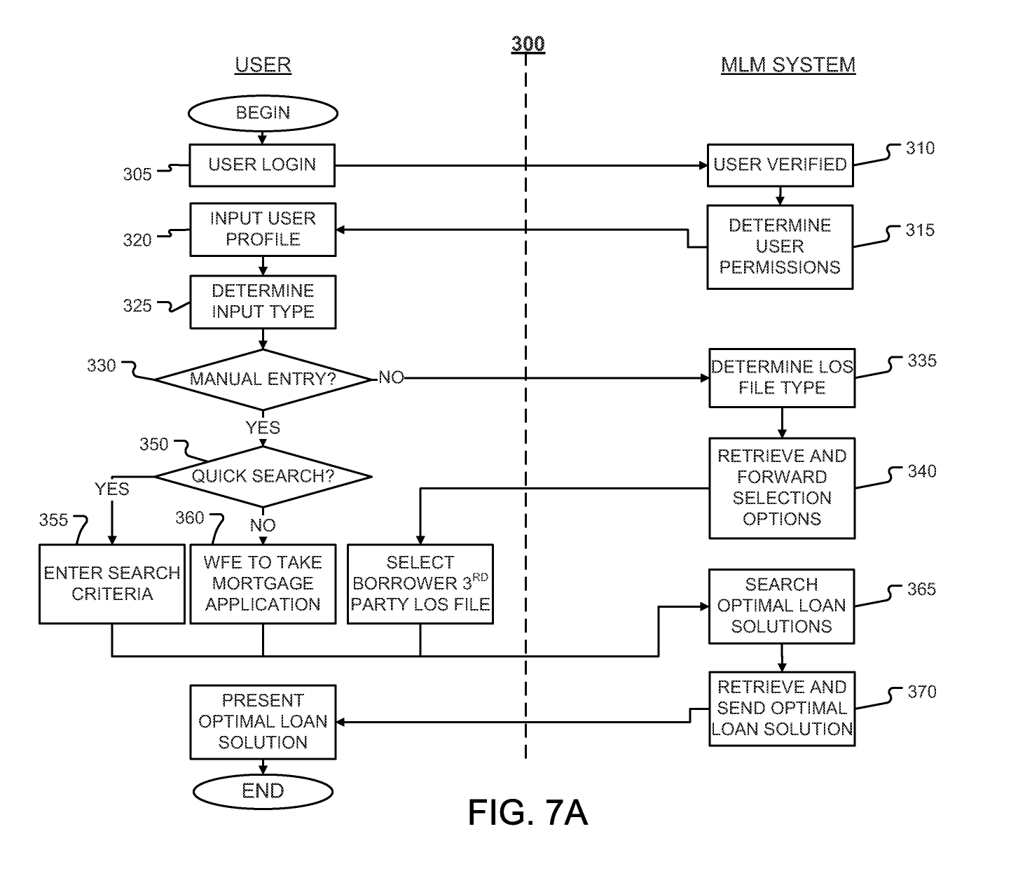

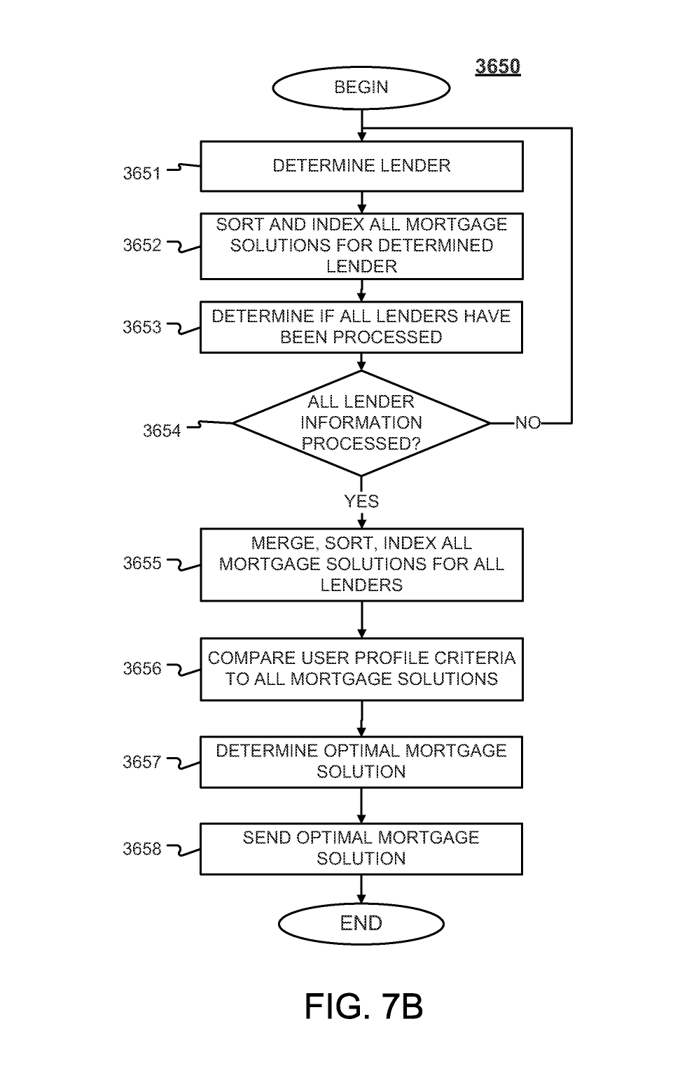

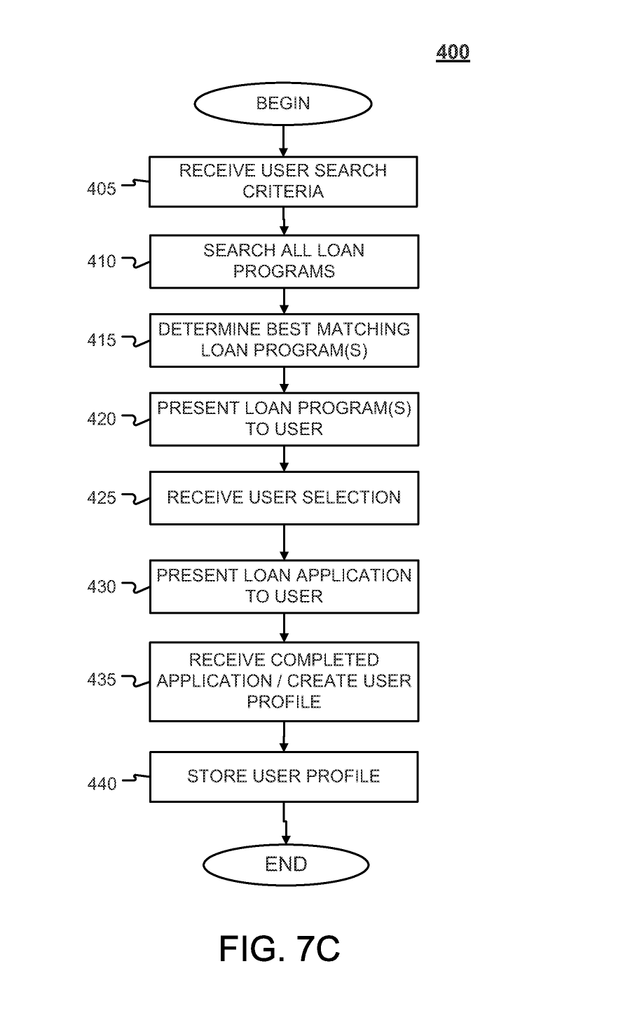

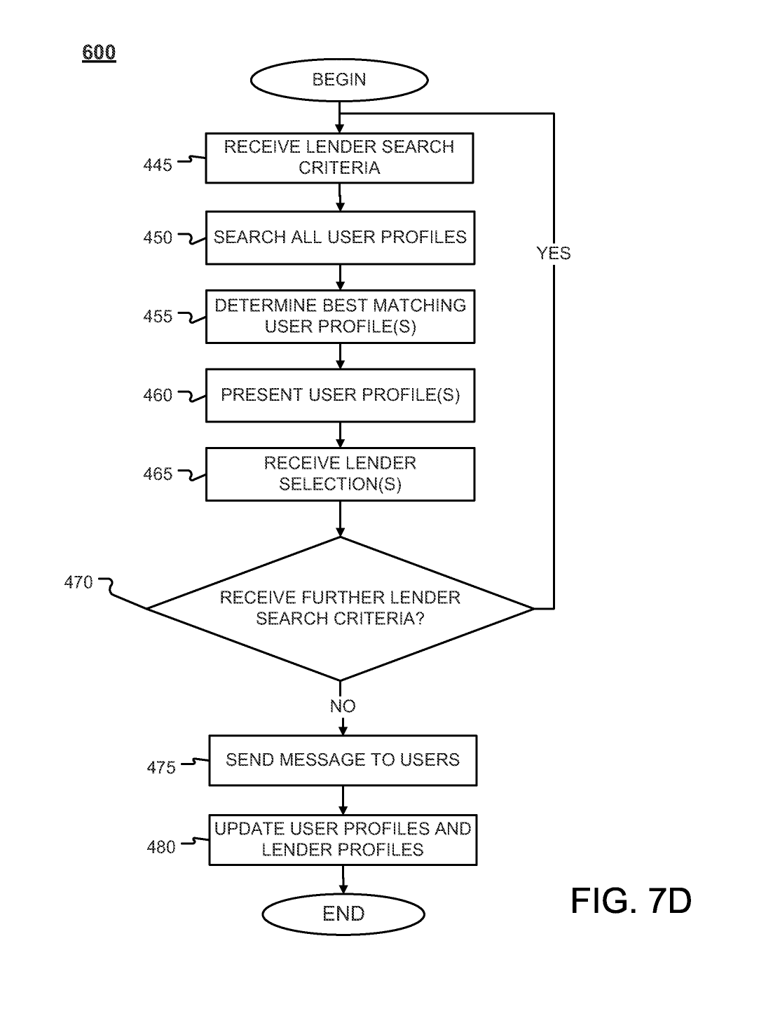

FIG. 7A shows an example of a process for determining an optimal mortgage solution;

FIG. 7B shows an example of a process for creating a mortgage solution;

FIG. 7C shows an example of a process for finding an optimal mortgage solution, according to the principles of the disclosure;

FIG. 7D shows an example of a process for finding one or more matching user profiles to one or more lender defined criteria;

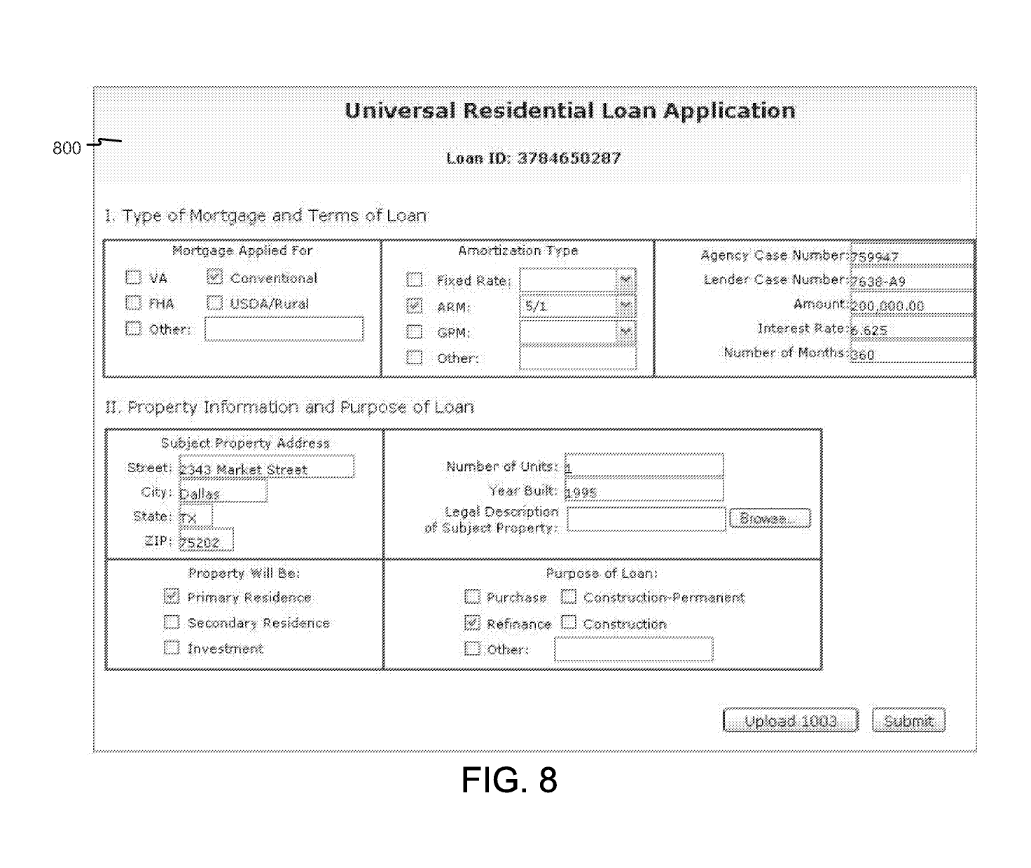

FIG. 8 shows an example of a universal residential loan application for a particular loan identification number (ID);

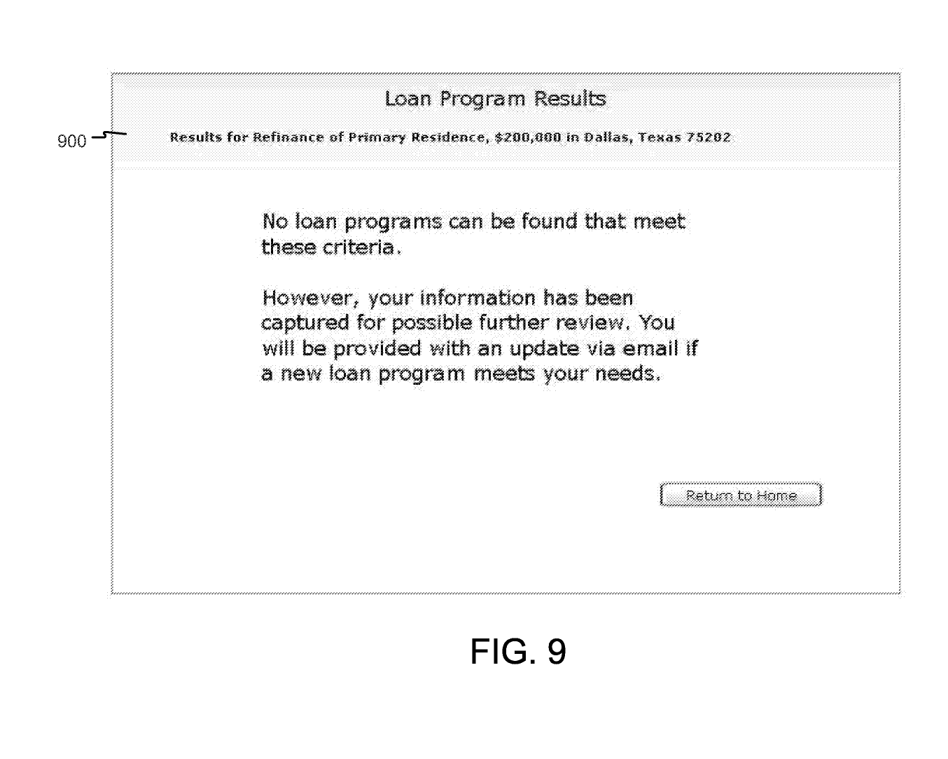

FIG. 9 shows an example of a loan program results display that may be presented to a user;

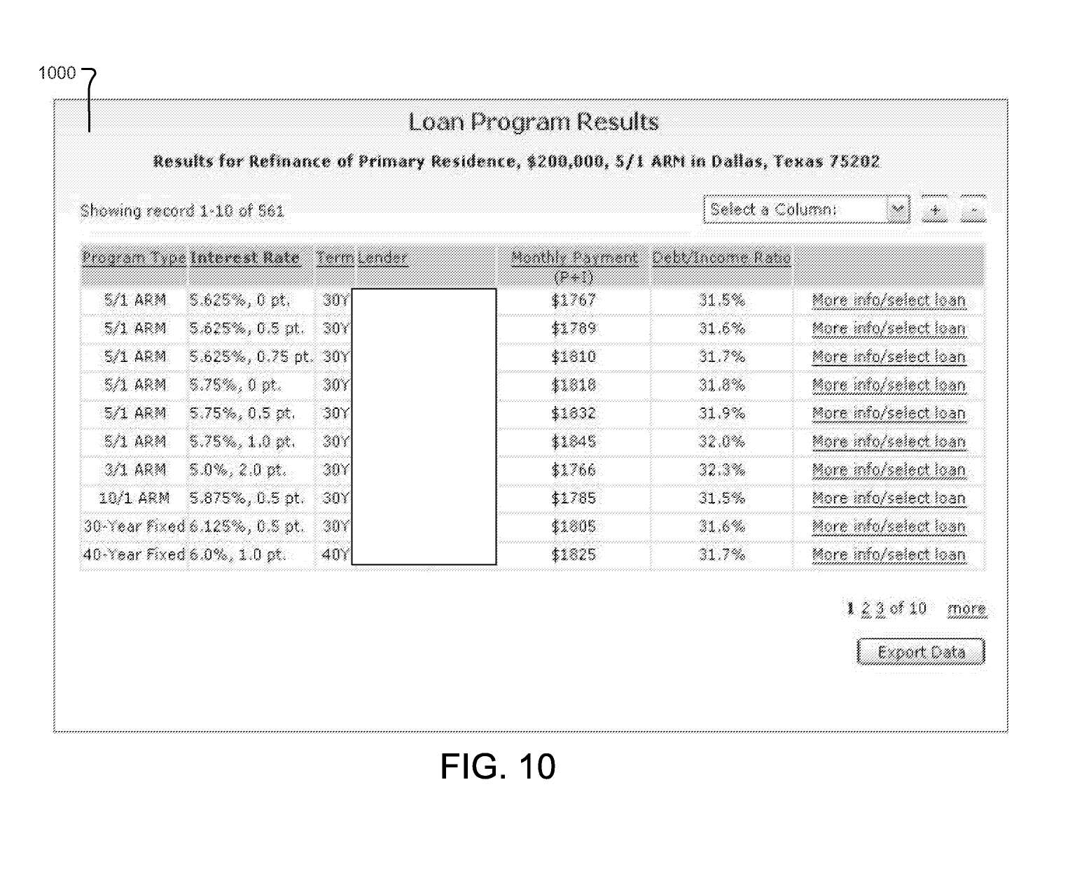

FIG. 10 shows an example of a loan program results display that is associated with the loan ID in FIG. 8, which may be presented to a user;

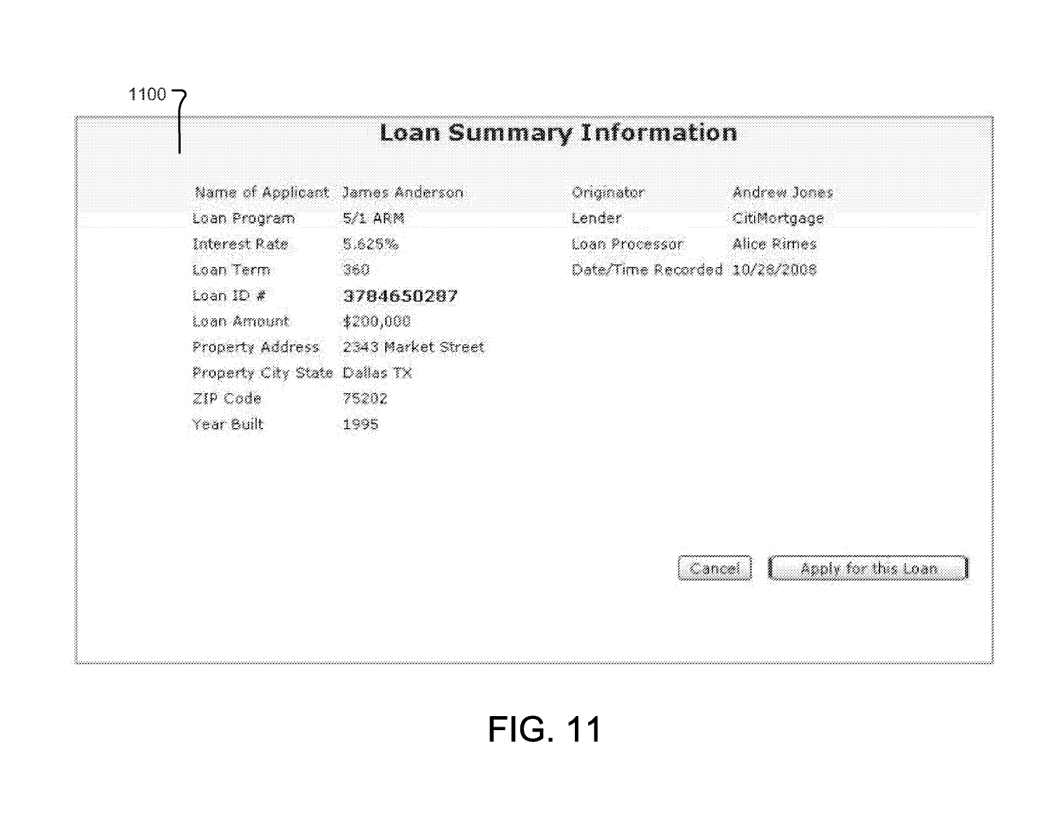

FIG. 11 shows an example of a loan summary information display that is associated with the loan ID in FIG. 8, which may be presented to a user;

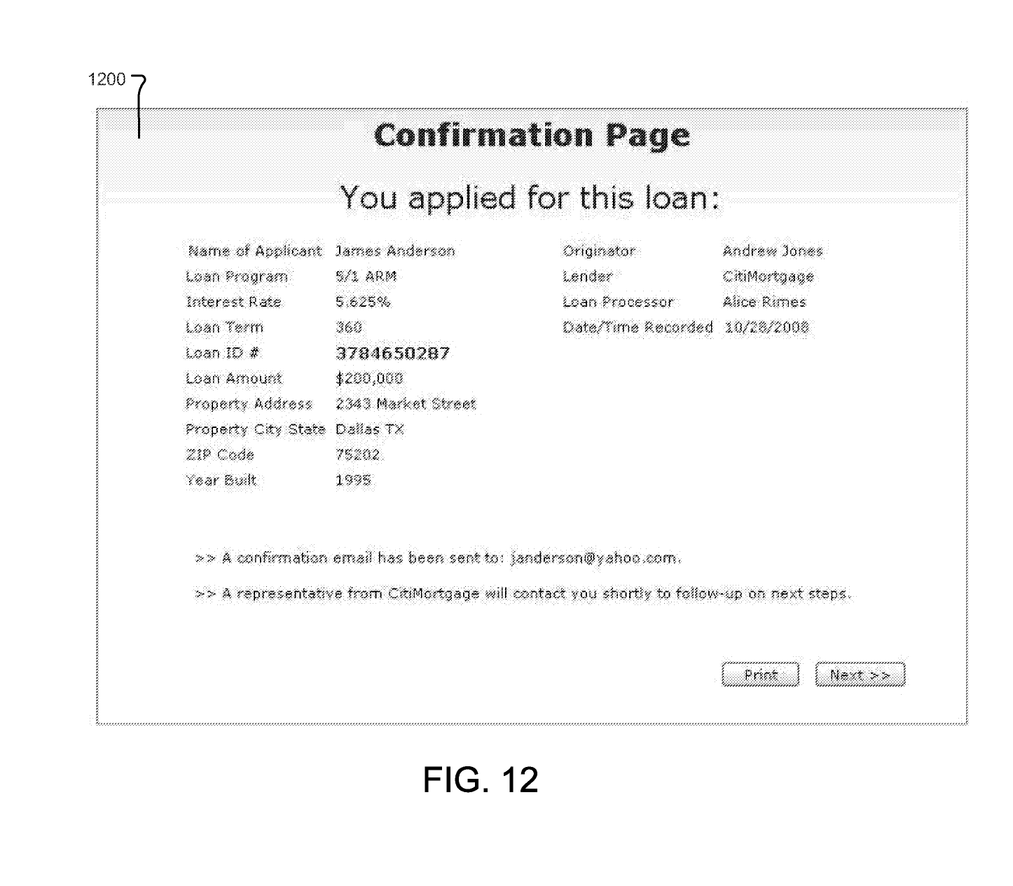

FIG. 12 shows an example of a confirmation page display that is associated with the loan ID in FIG. 8, which may be presented to a user;

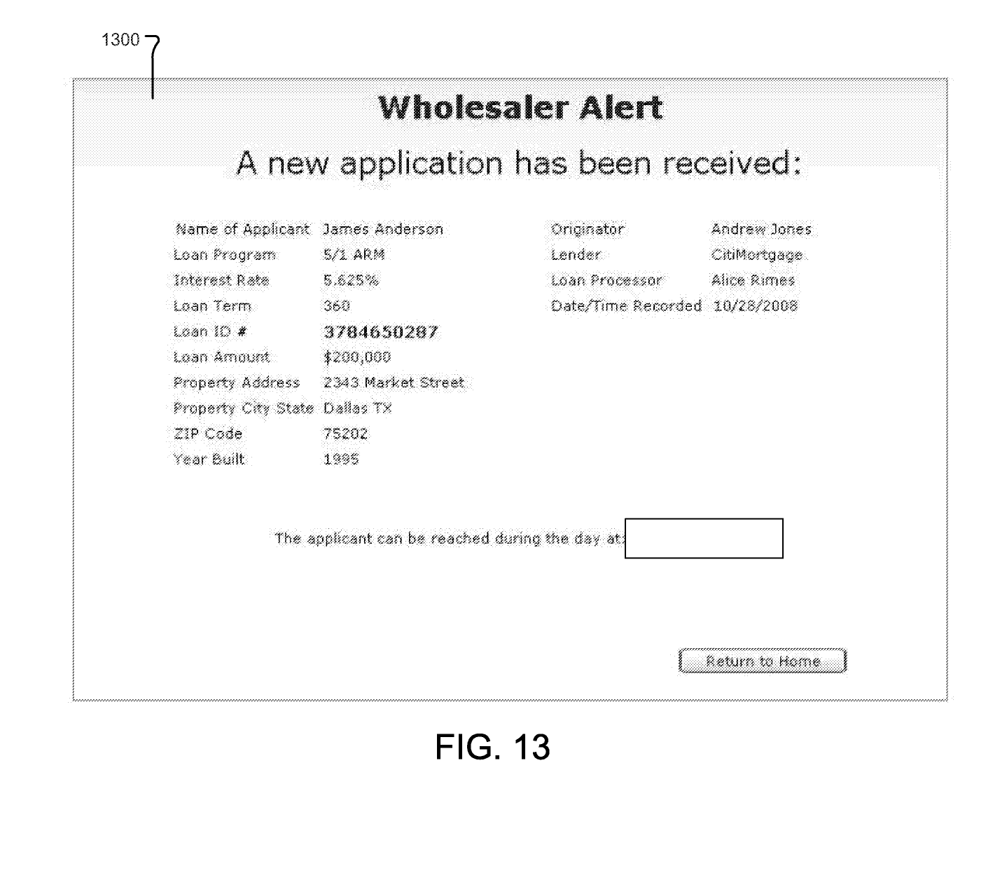

FIG. 13 shows an example of a wholesale alert display that is associated with the loan ID in FIG. 8, which may be presented to another user, who may be a wholesale lender;

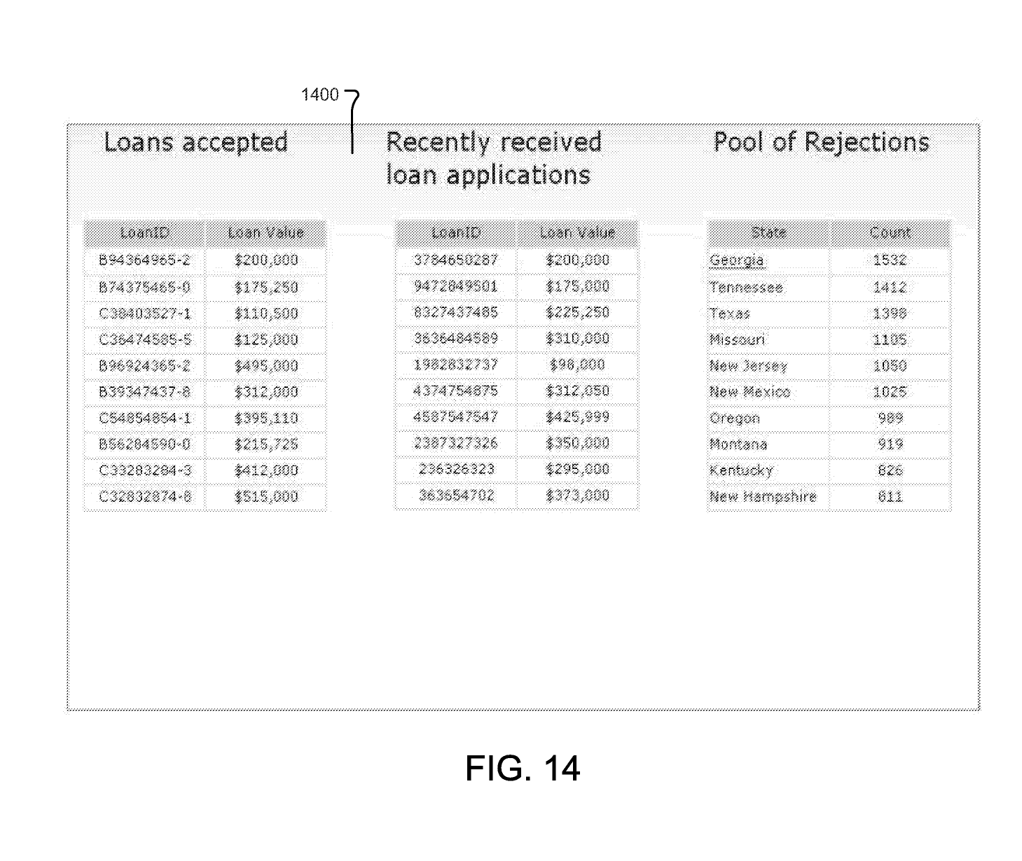

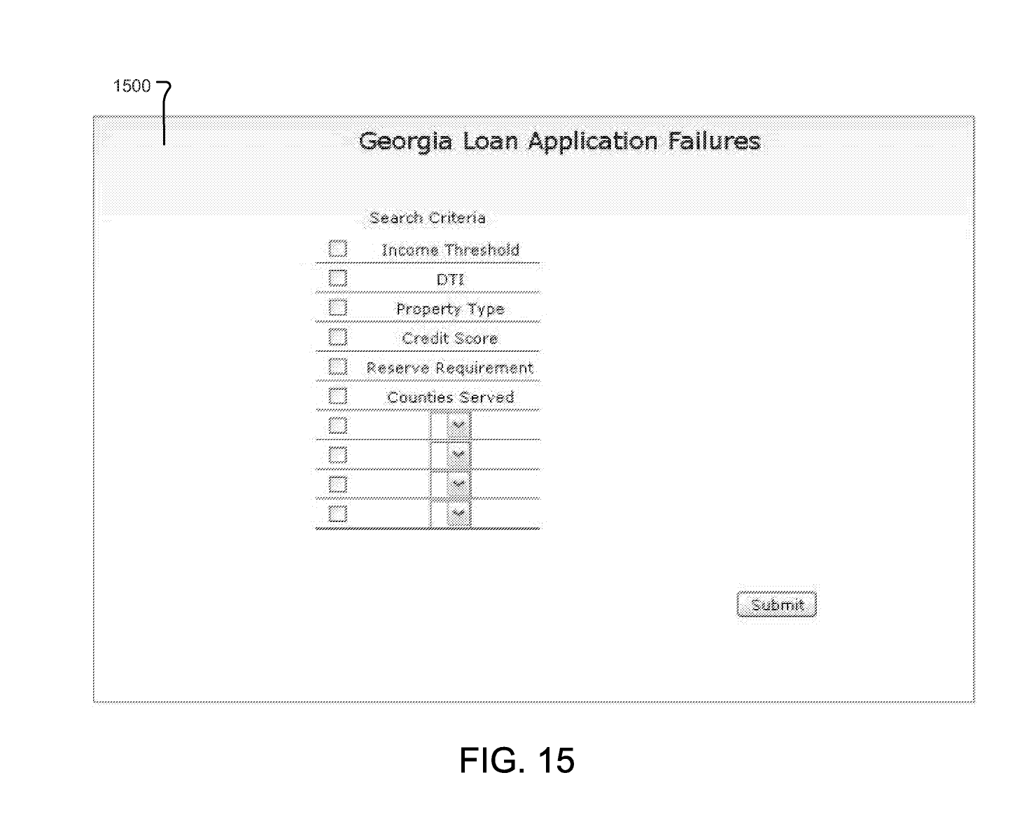

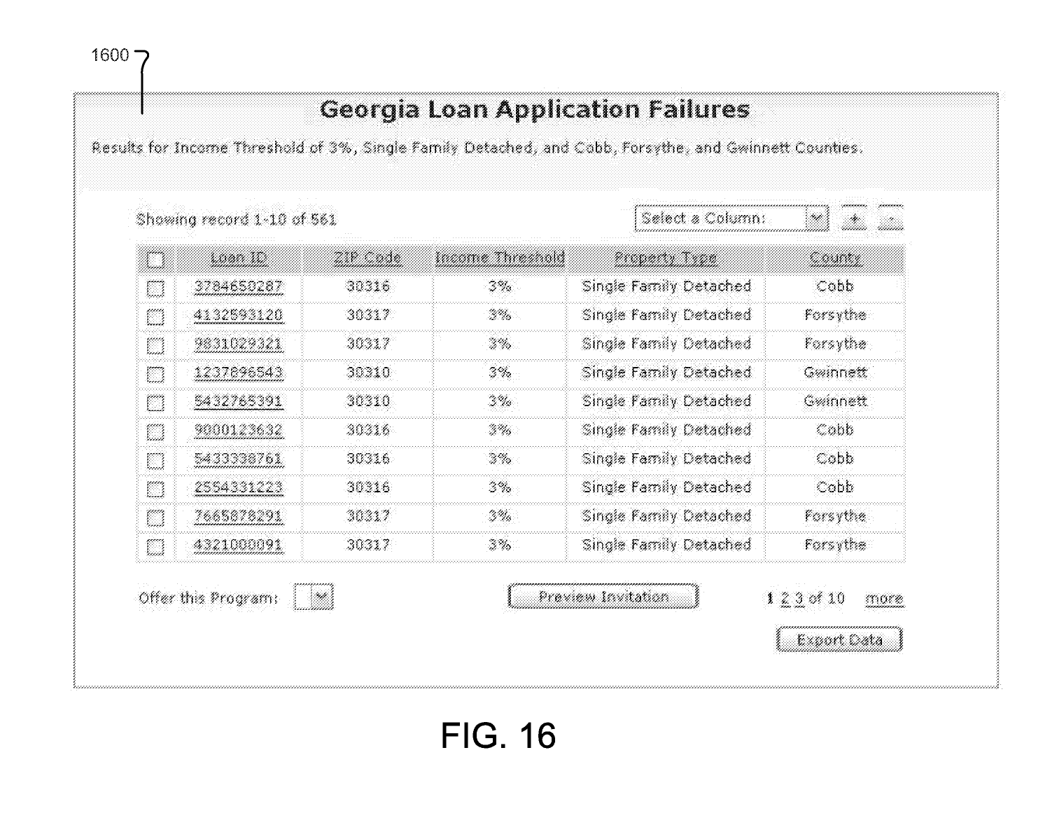

FIGS. 14-17 show examples of a wholesaler workspace display that may be presented to a user who is, e.g., a wholesale lender;

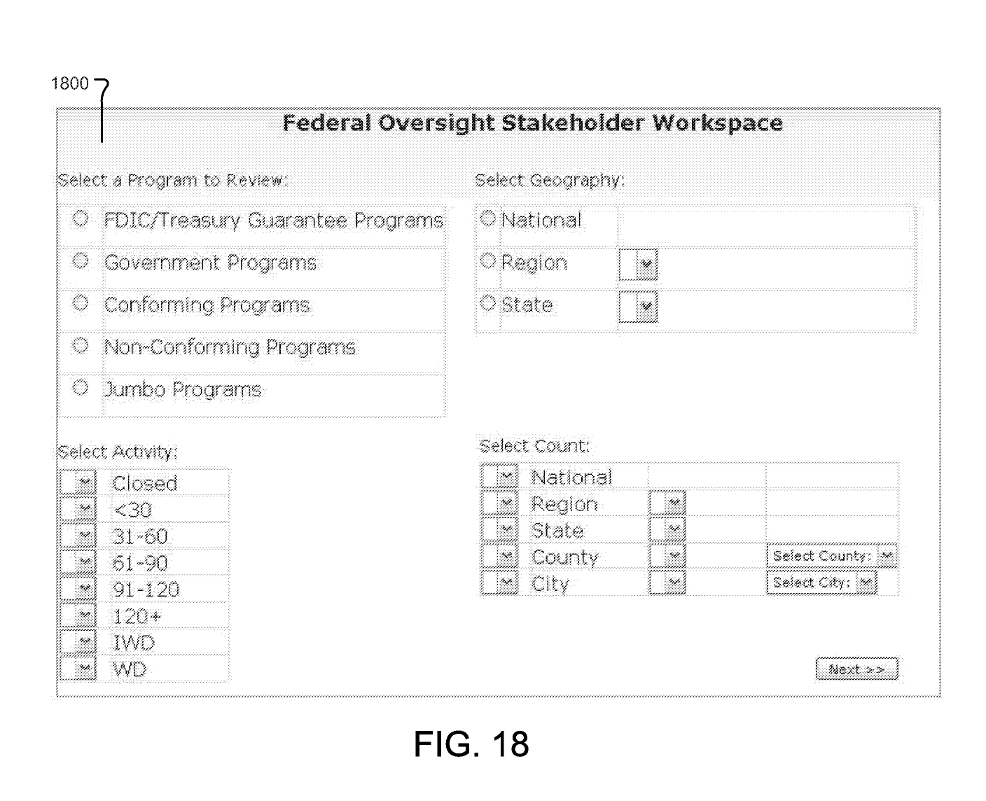

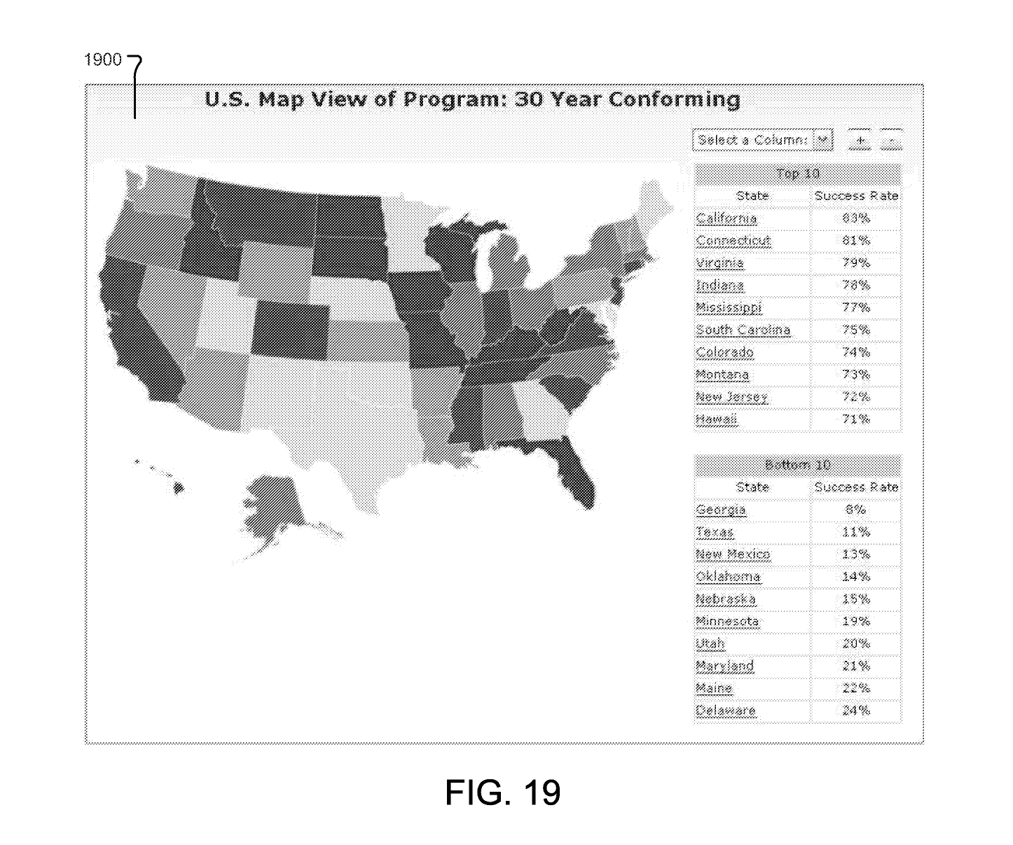

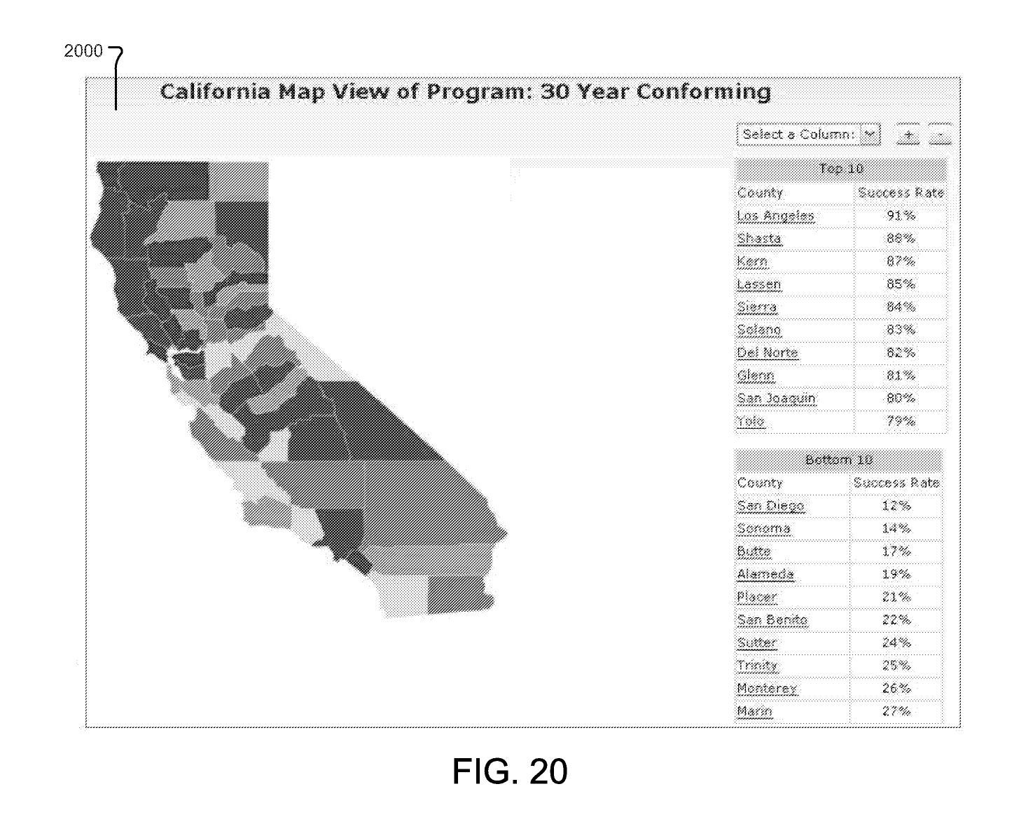

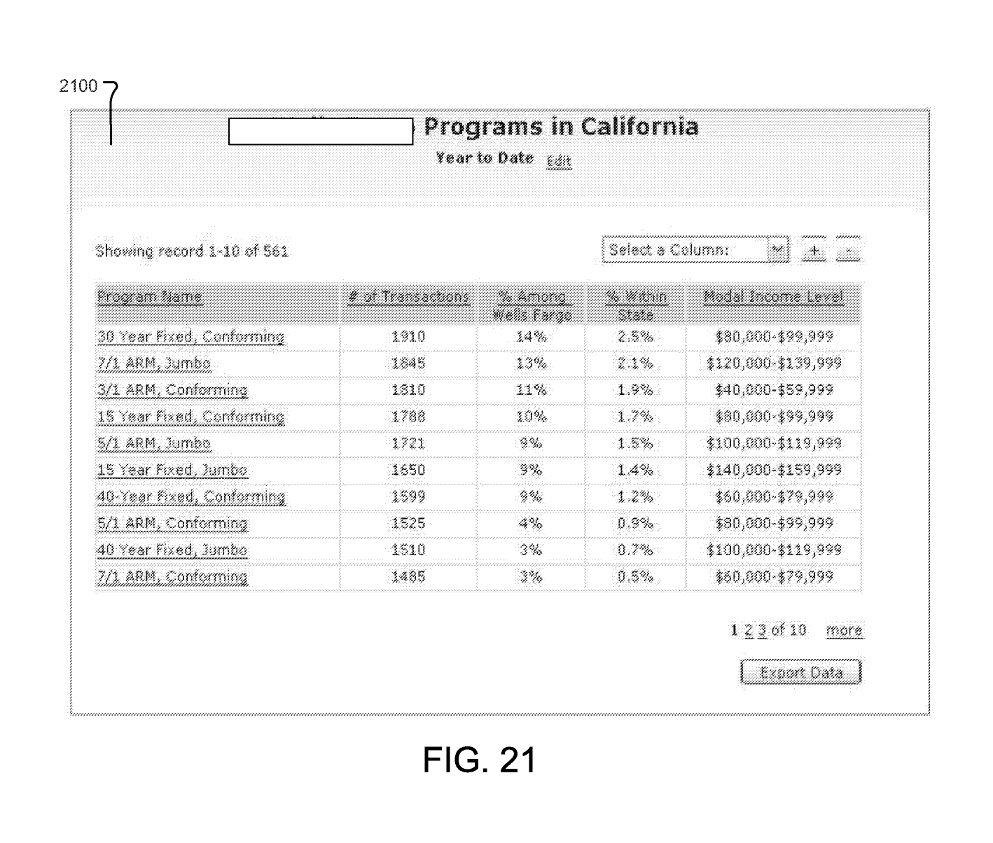

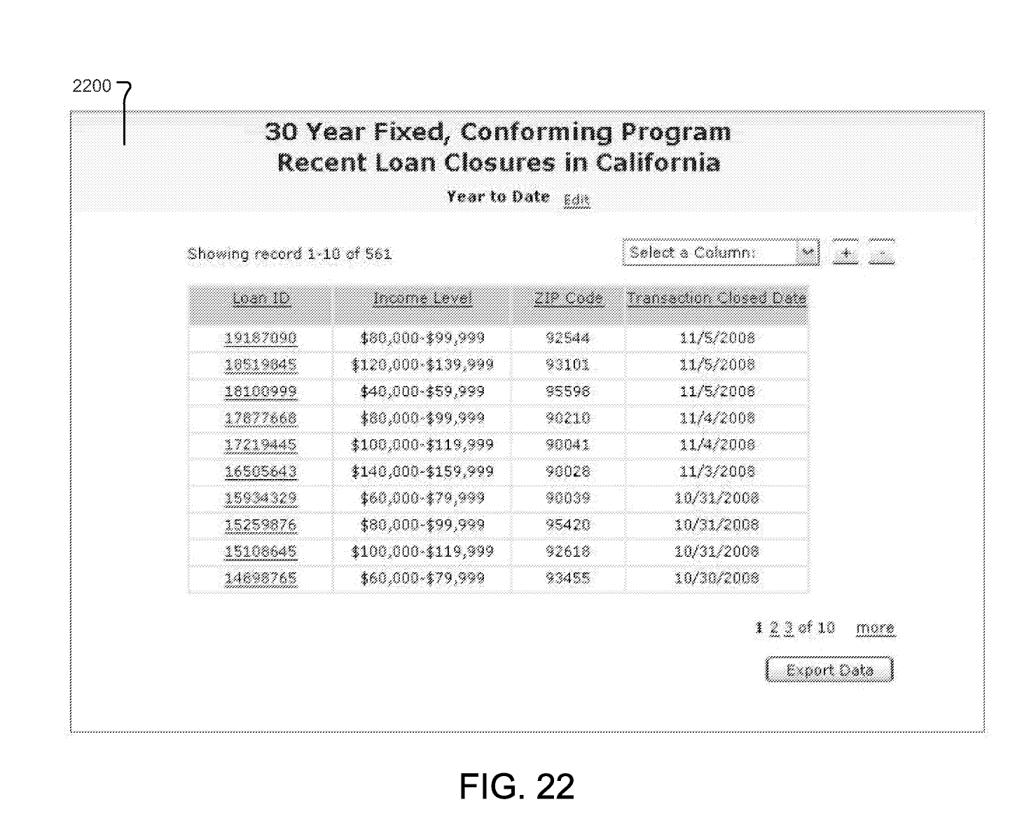

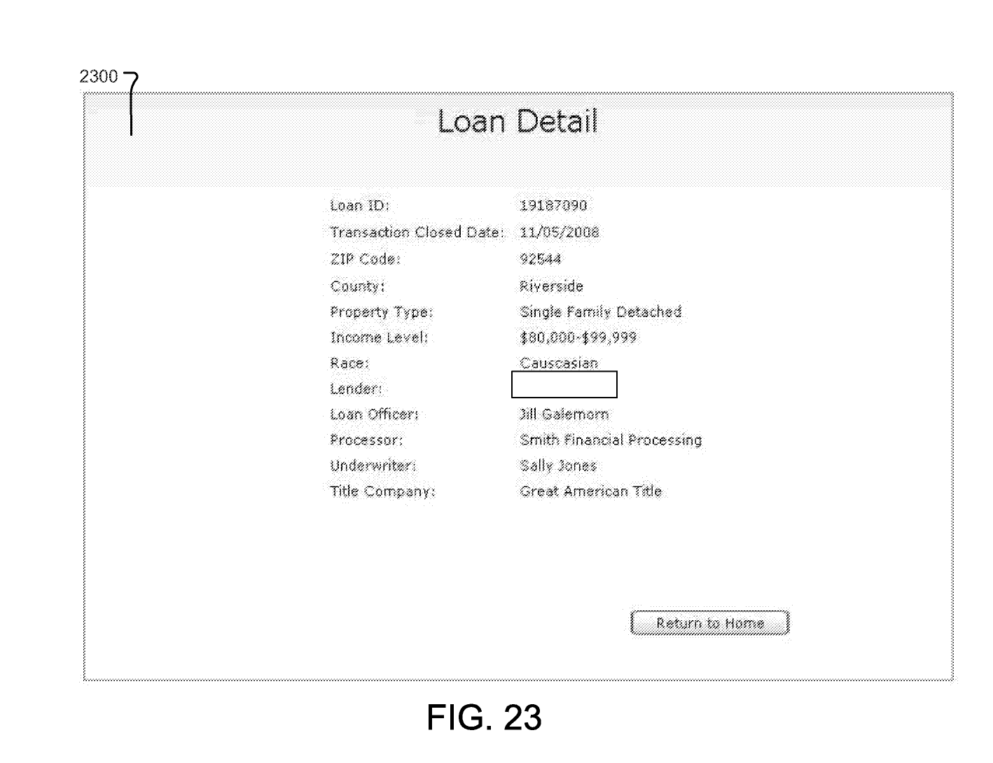

FIGS. 18-23 show examples of a federal oversight stakeholder workspace display that may be presented to a user who is, e.g., an investigator, an auditor, a regulator, or the like;

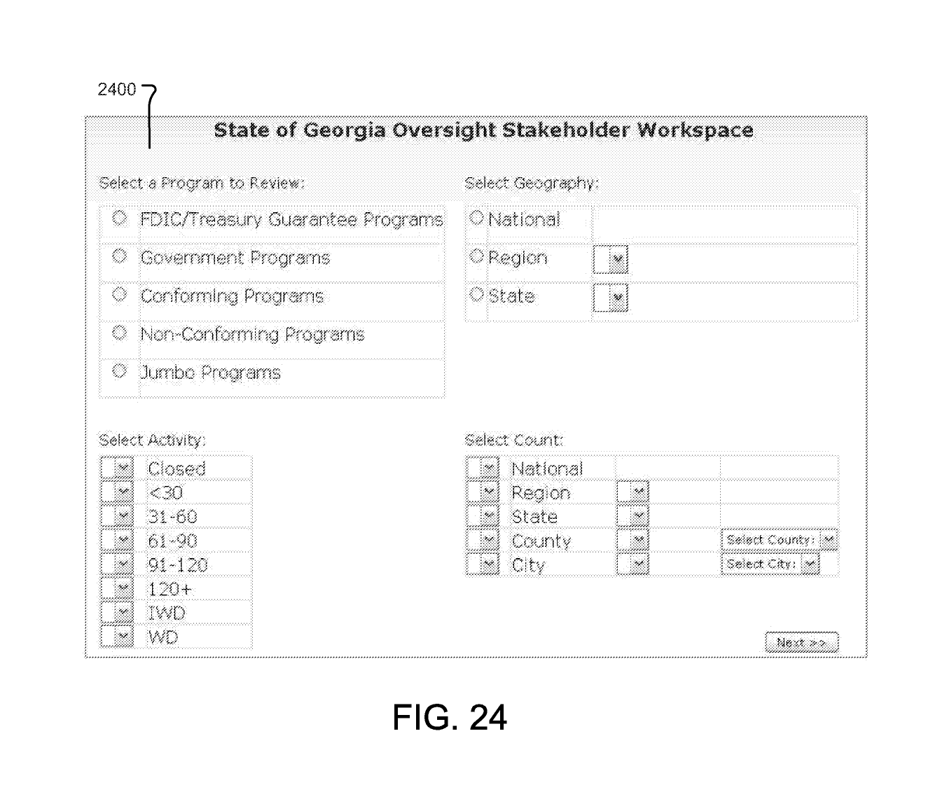

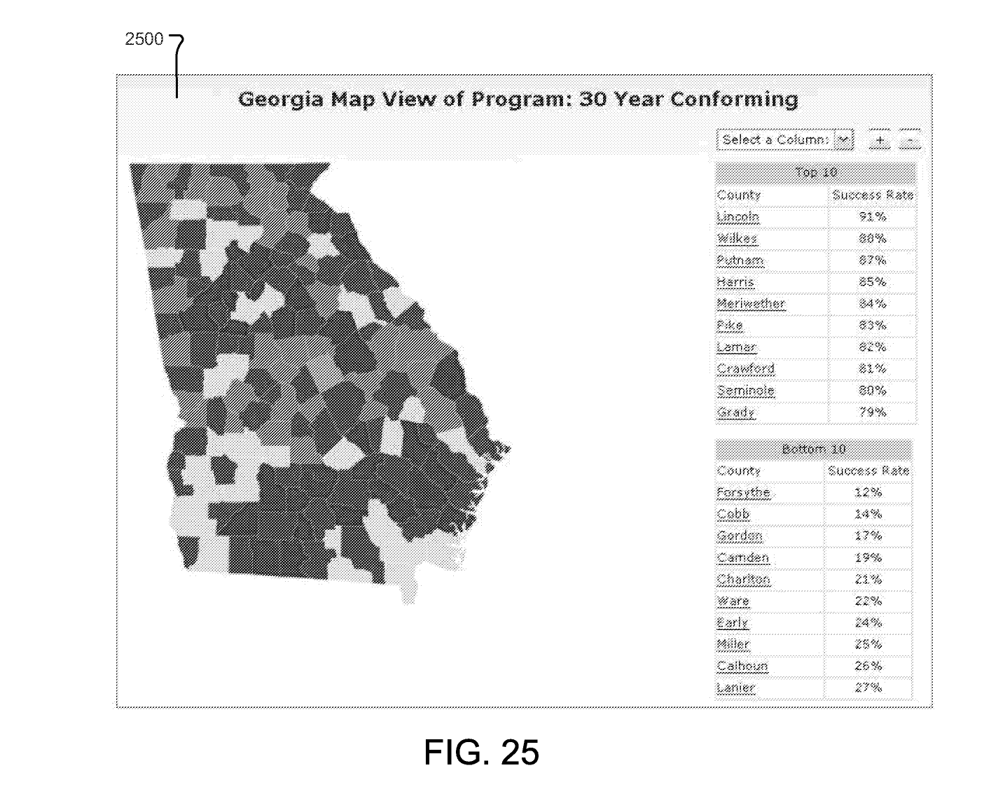

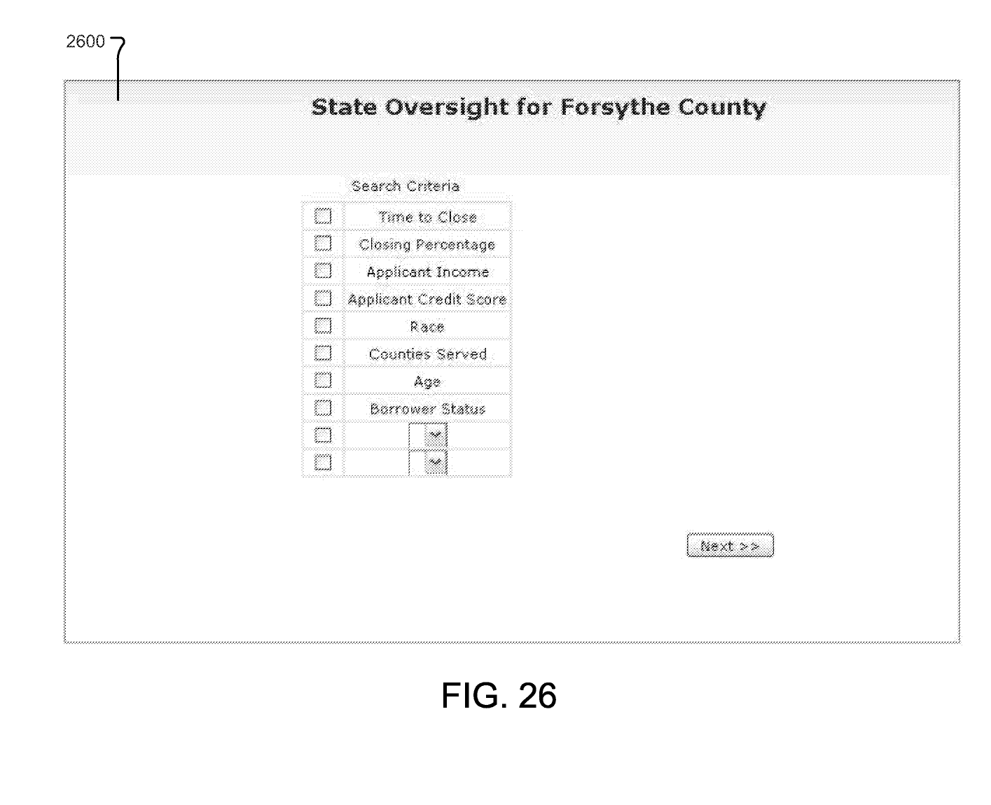

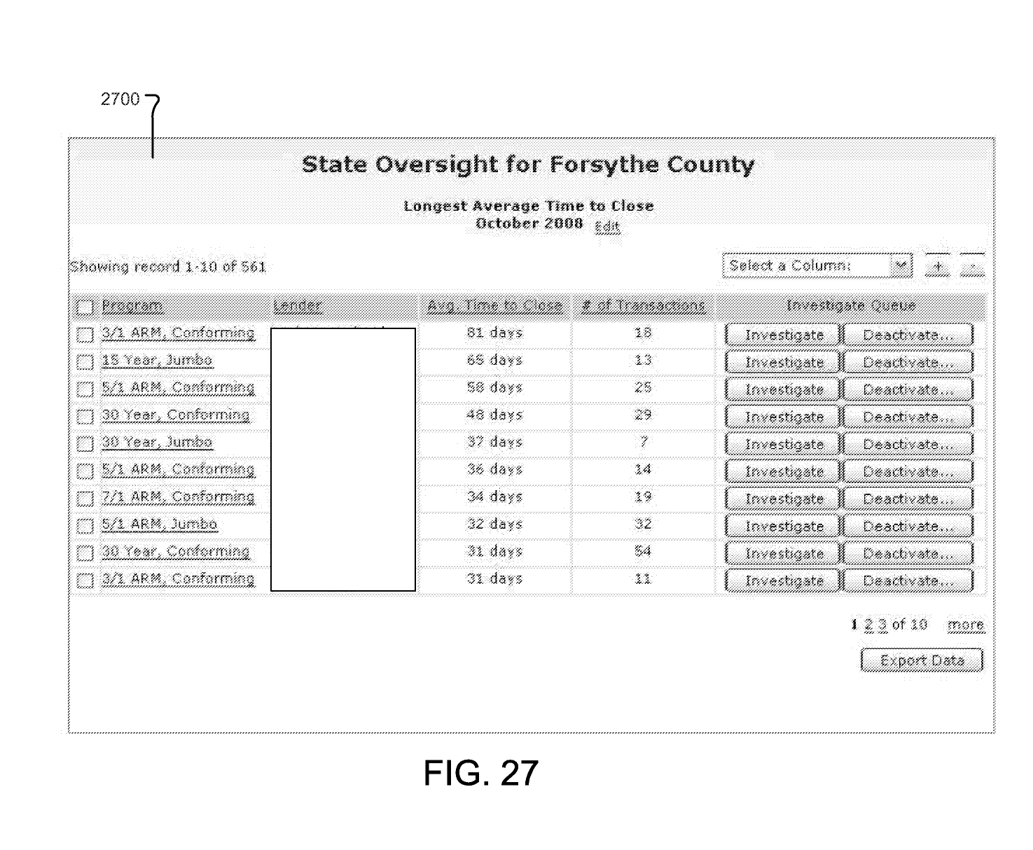

FIGS. 24-27 show examples of a state oversight stakeholder workspace display that may be presented to a user who is, e.g., an investigator, an auditor, a regulator, or the like; and

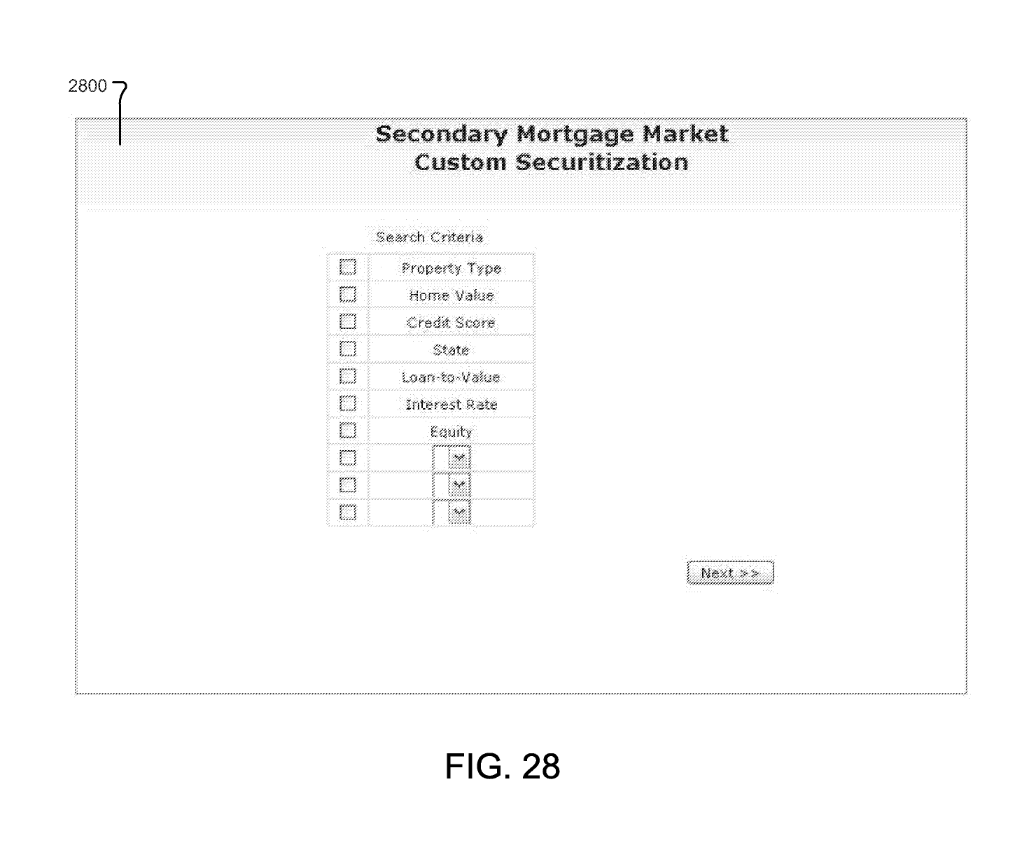

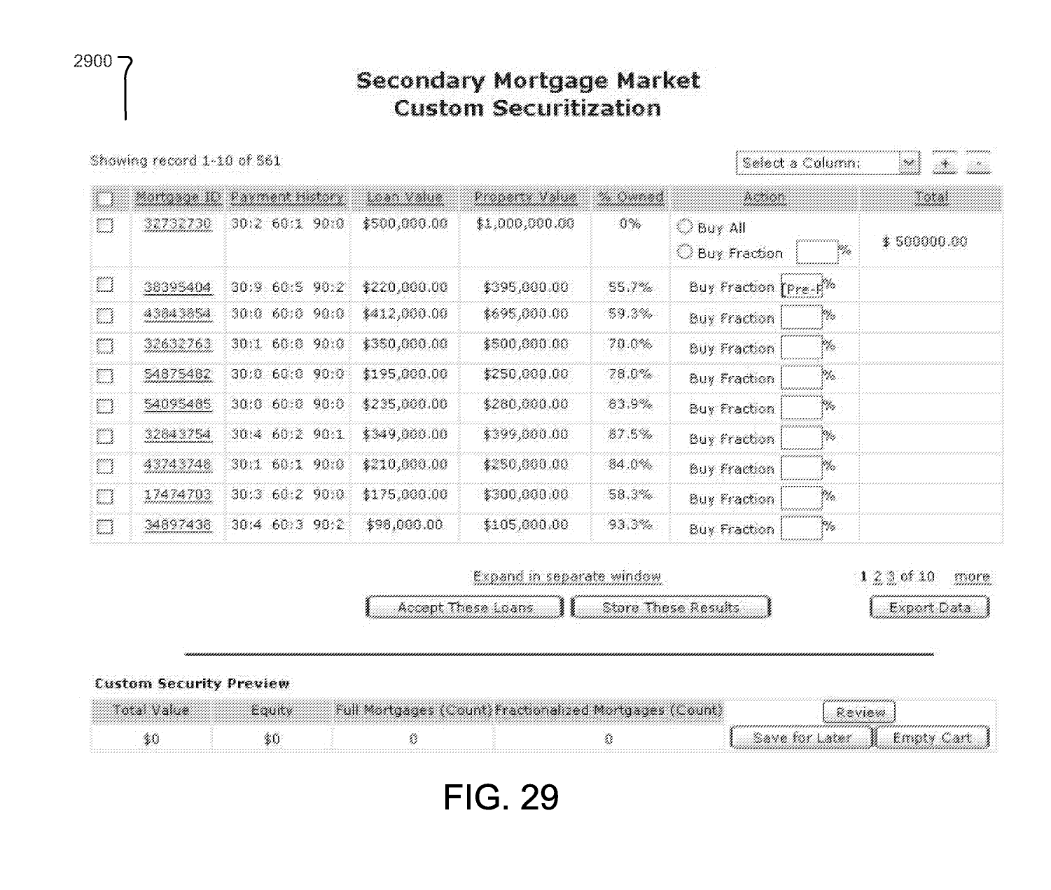

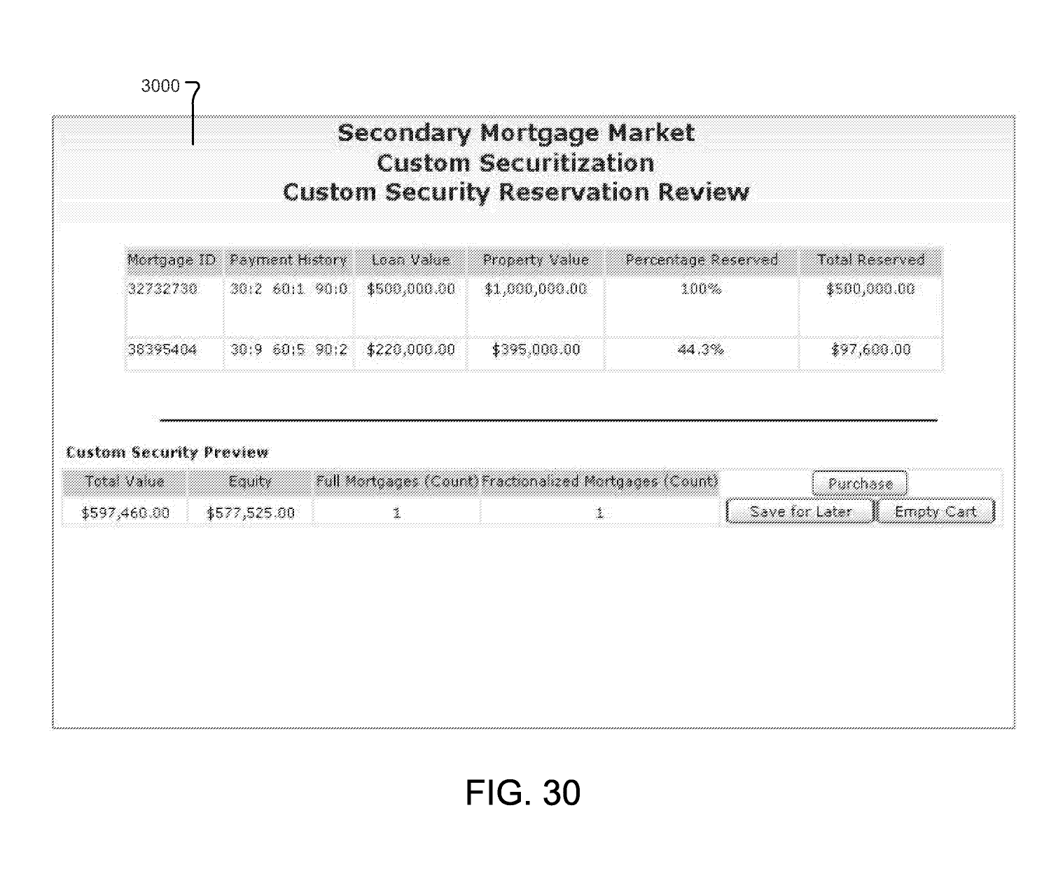

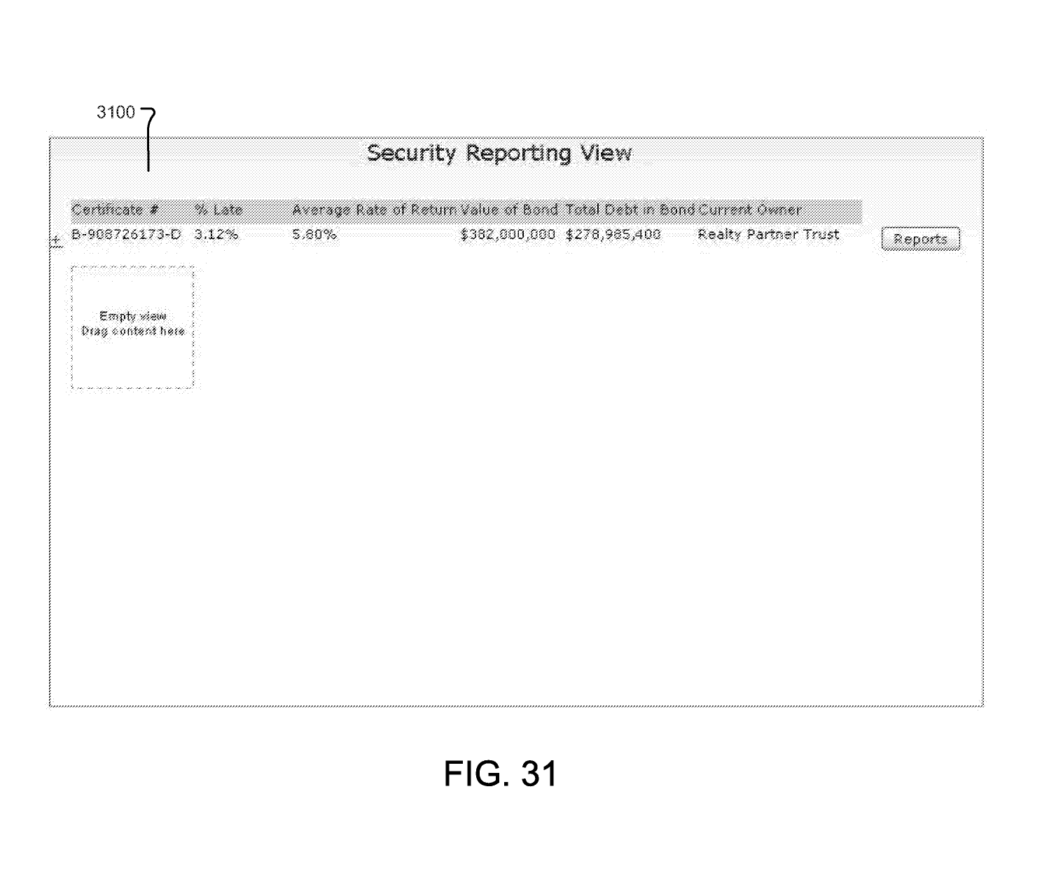

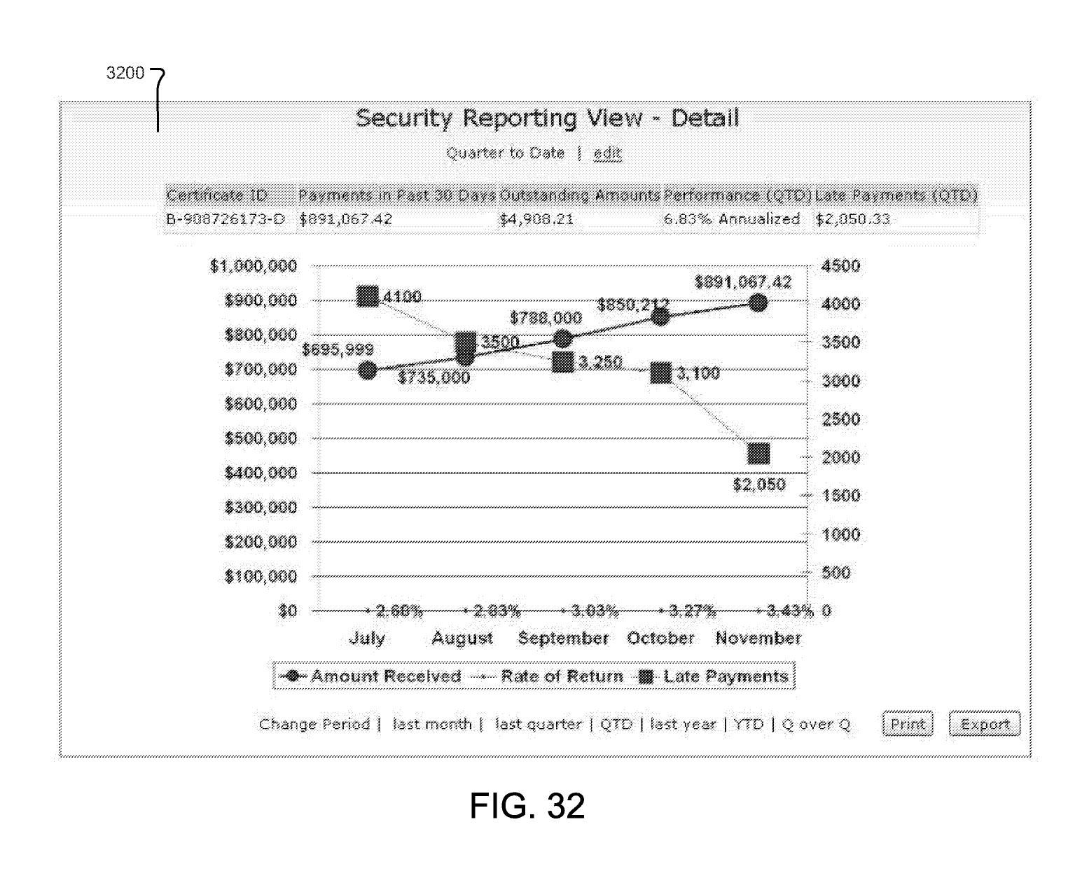

FIGS. 28-32 show examples of an investor workspace display that may be presented to a user who is, e.g., an investor, an institutional investor, an investment banker, a securitization agent, or the like.

The present disclosure is further described in the detailed description that follows.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as one of ordinary skill in the art would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those having skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which is (are) capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “network,” as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link” (or “communication links”), as used in this disclosure, means a wired and/or wireless medium that conveys data or information between at least two points. The wired or wireless medium may include, for example, a metallic conductor link, an air link, a fluid medium link, a radio frequency (RF) communication link, an Infrared (IR) communication link, an optical communication link, or the like, or any combination of the foregoing without limitation. The RF communication link may include, for example, WiFi, WiMAX, IEEE 802.11, DECT, 0G, 1G, 2G, 3G or 4G cellular standards, Bluetooth, or the like.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards. Bluetooth, or the like.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

FIG. 1 illustrates an example of a traditional mortgage lifecycle that consists of a regulated portion 10 and an unregulated portion 20. The regulated portion 10 comprises three stages, including an application stage, an origination stage, and an underwriting stage, all of which may be regulated by states and/or the federal government. The unregulated portion 20 includes a securitization stage. The regulated portion 10 is covered by both federal and state regulation.

In the regulated portion 10 of the traditional mortgage lifecycle, an end consumer 11 applies for a mortgage loan through a broker, such as a mortgage broker 12 or a bank 13. The underlying property is typically appraised by an appraiser 16 to determine a value of the property in relation to the requested loan. The broker 12 (or 13) forwards the mortgage loan application to a wholesale lender, such as a wholesaler 14 or a private institution 15, which underwrites the mortgage loan. The mortgage loan is entered unto the books of the wholesale lender 14 (or 15) as a balance-sheet asset. The wholesale lender 14 (or 15) may pool its various assets, including, for example, residential mortgages, commercial mortgages, auto loans, credit card debt, or the like, and sell the assets to a special purpose vehicle (SPV) 21 in the unregulated portion 20 (or secondary market) of the traditional mortgage lifecycle.

In the unregulated portion 20 of the traditional mortgage lifecycle, the SPV 21 bundles the underlying assets into one or more specified pools, which it then sells to investors in the form of shares 22-25 in the SPV 21 and derivatives 26-27.

The traditional mortgage lifecycle suffers from a number of systematic problems, including, for example, but not limited to: a lack of transparency; limited governance, monitoring and accountability; a poor reporting granularity; a lack of real-time data exchange; a lack of efficiency and competition; a susceptibility to inflated property values; a susceptibility to predatory retail lending practices; and the like.

FIG. 2 illustrates an example of a mortgage lifecycle, constructed according to principles of the disclosure. As seen in FIG. 2, various stakeholders are linked to a mortgage lifecycle management (MLM) system 100 through a plurality of communication links 18. The stakeholders may include, e.g., the consumer 11, the broker 12, the retail bank 13, the wholesale lender 14, the private institution 15, the appraiser 16, a regulator (not shown), a securitization participant (not shown), a title company (not shown), an insurer (not shown), an investor (not shown), a realtor (not shown), a lawyer (not shown), a builder (not shown), and the like. The communication links 18 may include a network. The MLM system 100 comprises a fully integrated exchange platform that provides the various stakeholders with real-time reporting, market intelligence, and accountability tools. The MLM system 100 includes a data model that stores and analyzes a confirmed consumer (or borrower) profile, all (or part) of the approved and denied mortgage applications, appraisals and vendors, and the like. The MLM system 100 is configured to provide timely, accurate, and relevant information to a user who is provided access to the MLM system 100. The user may be any one of the stakeholders mentioned earlier.

The consumer 11, for example, may communicate with the MLM system 100 through the communication link 18 to obtain loan information about one or more available loans, including a loan that best matches the consumer's requirements. The loan information may include, for example, interest rate(s), loan origination fee(s), closing fees, and the like. Initially, a consumer 11 may partner with a representative, such as, for example, a realtor, a retail mortgage broker (RMB), a lawyer (that's acting as a realtor), or the like, or the consumer may directly contact the MLM system to access the MLM system 100 and gain visibility into the status of each trading partner of a particular transaction. The consumer 11 may have complete visibility into peer-to-peer (P2P) transactions. The consumer 11 may be able to manage his/her own P2P transactions, such as, for example, a title request, an appraisal, loan conditions, and the like. This application may place a wholesaler in the traditional role of a retail lender.

A regulator (not shown), for example, may communicate with the MLM system 100 through the communication link 18 to obtain information for forensic and predictive analysis that may support the regulator's ability to better manage fraud and predatory lending practices. The regulator may obtain information that identifies the best loan for a particular consumer 11, the loan actually underwritten for the consumer 11, the loans that were available at the time consumer 11 accepted the loan, and the like. The regulator may receive real-time reporting of market intelligence, governance information, and the like.

A private institution (or individual) 15, for example, may communicate with the MLM system 100 through the communication link 18 to mine the data in the MLM system 100 for market intelligence and risk management, thereby driving system-wide accountability and providing an ability to create real-time spot markets based on market conditions created by consumer demand.

A realtor (not shown), a workflow manager (not shown), or the like, may communicate with the MLM system 100 through the communication link 18 to obtain visibility into the status of each trading partner in a transaction. Through, e.g., a realtor/consumer utility (RCU), which may be provided in the MLM system 100, the realtor, despite the side of a transaction they are representing, may be able to view their client's exact disposition within a P2P transaction, including, for example, charges, pre-approval status, loan commitment status, escrows, loan programs, and the like.

The MLM system 100 may also manage and govern whole loan and fractional security creation, monthly performance monitoring, persistent monitoring, and the like. The mortgage lifecycle according to principles of the disclosure may enable a scalable deployment of any banking policy nationally. The MLM system 100 is configured to provide transparency and substantially real-time data access, thereby facilitating improved risk assessment, risk management, and accountability.

FIG. 3 shows an example of an MLM server 110 that is communicatively coupled to a plurality of user devices 220 through a network 200 and a plurality of communication links. As seen, the MLM server 110 may be linked directly to one or more data store(s) 120. Alternatively, the MLM server 110 may be indirectly linked to the data store(s) 120 through, e.g., the network 200. The data stores 120 may each include one or more databases, as well as a database management system. The user devices 220 may each include a computer that is (or may be) configured to communicate with the server 110. The server 110 may be accessed by one or more users 210 through the user device(s) 220. As noted earlier, the users 210 may be any one or more of the stakeholders mentioned earlier. The users 210 (via the user devices 220) may dynamically build reporting and decision engines via semantic methods. The MLM system 100 may create a predefined fact table for each type of user 210 (e.g., for each of the various stakeholders) that allows for the most common queries. The MLM system 100 may include the MLM server 110 and the data store(s) 120.

The following are examples of semantic queries that may be used in the MLM system 100: “Stats surrounding fees paid to RMB by wholesaler (YSP)”; “which wholesalers produced loans?”—“by loan type”, “by volume”, “by total amount”, “by data range”; “what is the difference between loans borrowers qualified for and those chosen by RMB's?”—“by loan program type”, “by Yield Spread Premium (YSP)”, “by underwriting guidelines”; “what are the closing cost statistics?”—“by demographics”, “by geography”, “by property type”, “by loans with no closing costs”, “by loans with PMI”, “by % of lender fees to purchase price”, “by borrowers who have declared bankruptcy”; “what are the interest rate statistics?”—“by demographics”, “by geography”; “where did borrower move from/to?”—“by demographics”, “by geography”; “average interest rate, amount and repayment terms for home equity lines of credit and loans?”—“by demographics”, “by geography”; and the like.

The data stores 120 may include, e.g., consumer (or borrower) records, loan applications (both approved and denied loan applications), appraisals, vendor records, wholesale lender records, builder records, insurer records, state compliance records for relevant stakeholders, insurance policies, and the like. The data stores 120 may be updated at predetermined intervals, or substantially continuously to ensure that the data stores 120 are populated with the most up to date information available.

The MLM server 110 may create and manage a user record for each of the users 210 that have been registered in the MLM system 100 (shown in FIG. 2). The user record may be stored in the data store 120. The user record may include a user profile that includes a plurality of fields, including a user name field, a user title field, an identification number (e.g., a social security number, a residency card number, etc.) field, an address field, a zip code field, an area code field, a telephone number field, an email address field, and the like. The user profile may further include user defined criteria, such as, for example, a loan amount, an interest rate (e.g., APR), a loan term (e.g., 15 years, 30 years, or the like), a number of origination points (e.g., 0, 1 point, 2 points, or the like), a loan type (e.g., a fixed loan, a variable loan, an ARM loan, a mortgage applied for, a case number, an amortization type, a home type, and the like), and the like. The user profile may also include additional information, such as, e.g., insurance data, income data, bank account data, credit history data, and any other type of data that may be relevant to loan origination, loan underwriting, loan information auditing, investigation, or regulation by the various stakeholders that may be given access to the information in the MLM system 100. The MLM system 100 captures the user records and the individual mortgage applications and archives each data point at an atomic level.

The MLM server 110 may further create and manage a lender record for each of the users 210 that have been registered in the MLM system 100 (shown in FIG. 2) as a lender. The lender record may be stored in the data store 120. The lender record may include a lender profile that includes a plurality of fields, including a lender name field, a lender title field, an identification number (e.g., a tax identification number, etc.) field, an address field, a country code field, a geographic region code field, an area code field, a telephone number field, an email address field, and the like. The lender profile may further include lender defined criteria, such as, for example, a loan amount, an interest rate (e.g., APR), a loan term (e.g., 15 years, 30 years, or the like), a number of origination points (e.g., 0, 1 point, 2 points, or the like), a loan type (e.g., a fixed loan, a variable loan, an ARM loan, a mortgage applied for, a case number, an amortization type, a property type, a home type, and the like), and the like. The lender profile may also include additional lender defined criteria, including, e.g., insurance data, income data, bank account data, credit history data, and any other type of filtering criteria that may be relevant to matching, originating, underwriting, and maintaining an optimal loan program to a given user profile. The lender defined criteria may include the parameters necessary to provide complete transparency during an entire life cycle of a mortgage, which may be used for purposes of auditing, investigation, or regulation by the various stakeholders that may be given access to the information in the MLM system 100. The MLM system 100 captures the lender records, including the lender profiles and all of the lender loan programs offered by the respective lenders, archiving each data point at an atomic level.

FIG. 4 shows an example of a suite (or manager) 30 of highly scalable and component neutral (HSCN) applications that are built upon an access-agnostic platform. It is noted that other system models may be used, as one of ordinary skill in the art will appreciate, consistent with the scope and spirit of the instant disclosure, which retrieve (or receive) and match a given user profile to an entire universe of stored (or received) lender profiles and lender loan programs (or products) offered by each of the lenders, providing transparency throughout the entire mortgage lifecycle; or which retrieve (or receive) and match a given lender profile to an entire universe of stored (or received) user profiles, identifying a subset of the universe of user profiles that match, e.g., the lender defined criteria in the lender profile, or which are input by the lender in real-time, providing transparency during the entire mortgage lifecycle. The HSCN suite 30 may be provided in the MLM system 100 (shown in FIG. 2), and more specifically, in the MLM server 110 (shown in FIG. 3). The HSCN suite 30 may include a plurality of layers, as seen in FIG. 4. The HSCN suite 30 may include a data repository access layer 31, an evault layer 32, an openmarket layer 33, an applications layer 34, and a network layer 35. The HSCN suite 30 may communicate with the data stores 120 (shown in FIG. 3) through the data repository layer 31. The openmarket layer 33 may include a decision engine 33-1, a licensing manager 33-2, an assignmark (AM) 33-3, and an escrow manager 33-4. The applications layer 34 may include a transaction manager 34-1, a user manager 34-2, a content manager 34-3, a pricing manager 34-4, a charging manager 34-5, and a workflow manager 34-6. The HSCN suite 30 may further include a loan origination systems (LOS) and web front end (WFE) 36-1, an integration adapter 36-2, a realtor/consumer utility (RCU) 36-3, a reporting/analytics writer (RAW) 36-4, a platform manager 37-1, an omnex 37-2, a security manager 38-1, and a web services manager 38-2, all of which may be built atop of the network layer 35.

The evault layer 32 may be built atop of the data repository layer 31 to enable communication and operation of the remaining applications in the HSCN suite 30. For example, queries that are modeled by evault layer 32 (such as, e.g., dynamic client reporting and analytics via the RAW 36-4) may be extracted from data stores 120 (shown in FIG. 3) via the data repository layer 31 based on pre-constructed queries or client requests.

The decision engine (DE) 33-1 may include a rules and logic engine that both constructs wholesale lender loan program data and presents “best program” solutions to the LOS 36-1 and RCU 36-3 graphic user interfaces (GUIs). The decision engine 33-1, or any of the individually noted application in the HSCN suite 30, may be separate from the HSCN suite (or manager) 30. The decision engine 33-1 is configured to transform information into intelligence by supporting dynamically chosen variables for which to compare, dynamically creating rules base on the variables chosen, allowing for queries to return useful information, and supporting the ability of a user 210 to semantically assign information relevant to their query. The decision engine 33-1 may include artificial intelligence such as, e.g., a neural network, fuzzy logic circuits, or the like. When a user 210 (such as, e.g., a loan officer, a realtor, a borrower, or the like) requests mortgage information or places an order for a mortgage for a particular borrower, the decision engine 33-1 may process the request to identify the loan that best matches the particular borrower's user profile. Once a loan program is selected, the decision engine 33-1 may package the information for the appropriate lender and either present the packaged information to the lender via the LOS 36-1, RCU 36-3, RMB, or the like, or notify an automated underwriting system (AUS) for wholesale processing.

When a user 210, who is, e.g., a mortgage broker, wants to know which lender programs, of those that the borrower qualifies for, have the highest closing percentage and shortest duration for closing, the decision engine 33-1 may dynamically associate the variable “Percent_to_Close” and “Time_to_Close” with a fact table “Fact_Loans_Available” to determine the best matching lender program. The decision engine 33-1 allows for rules that, e.g., count all loan programs that a particular borrower qualifies for, including the same loan programs that may have been previously chosen by other mortgage brokers, determining those loan programs that closed from all of the identified loan programs and performing a ratio-calculation between the number of times a loan program was chosen for closing and closed and the number of times the loan program was chosen for closing and did not close.

The licensing manager 33-2 may monitor state-specific compliance information provided of users 210, such as, e.g., wholesale lenders, RMBs, and the like. The compliance information may be received from state-specific sources that provide information concerning the compliance by the users with state requirements. The compliance information may be audited to ensure compliance with state requirements. The compliance information may be stored in the data stores 120.

The assignmark 33-3 manages the P2P status and disposition of all mortgage requests from the workflow manager 34-6. The assignmark 33-3 may maintain the data that may be required when the workflow manager 34-6 is queried for a request on the status of a loan by a user 210.

The following modules in the HSCN suite 30 manage, maintain and control the flow of various types of information in the MLM system 100: The escrow manager 33-4 manages escrow status/disposition information; the transaction manager 34-1 manages transaction information; the user manager 34-2 manages user information; the content manager 34-3 manages content information; the pricing manager 34-4 manages pricing information and presents loan program information to the LOS 36-1 and RCU 36-3; the charging manager 34-5 manages charge information and presents charges for all pertinent parties via respective interfaces (such as, e.g., the RCU 36-3, the RMB, etc.); and the workflow manager 34-6 manages workflow.

The LOS 36-1 manages successful uploads (and/or downloads) of, e.g., third trading partner LOS specific files for the decision engine 33-1 and robust P2P status reporting for the loan origination. The LOS 36-1 may include, e.g., a JAVA-based applet that uses a very thin-client architecture, which may provide an interface that can be used to directly enter data. The LOS 36-1 may be used as either an enterprise LOS application or a web-based LOS (e.g., via a series of questions to which the DE 33-1 may then provide solutions or answers).

The integration adapter 36-2 may include a plurality or suite of adapters that are configured to integrate trading partners' (such as, e.g., wholesalers, insurers, title companies, RMBs, and the like) back office systems to the MLM system 100. The integration adapters 36-2, which may include a suite of applets, may include, e.g., JAVA-based adapters that may be used for workflow manager 34-6 reporting, automating processes necessary for loan closings (such as, e.g., underwriting, RMB processing, secondary market loan packaging, etc.), and the like.

The RCU 36-3 may include, e.g., a JAVA-Beans WFE to provide visibility into the status and disposition of the loan process via assignmark 33-3. The RCU 36-3 may also serve as a web-based LOS or third party LOS application for data entry, through data that may be captured via a series of questions, to which the DE 33-1 may then provide answers or solutions.

The RAW 36-4 may include, e.g., an applet that may be used by both wholesale lenders and RMBs. The RAW 36-4 provides preconstructed reports based on predefined queries. The RAW 36-4 may provide users with the capability to create custom queries against the evault layer 32. Additionally, the RAW 36-4 may also provide users with an ability to extract data for their own data warehouses.

The platform manager 37-1 may include, e.g., a suite of tools that provide administrative management of the MLM system 100, including service and performance management of the various components within the MLM system 100.

FIG. 5 shows an example of a display screen 500 that displays four different examples of suite tools, including an origination tool 510, an analytics and governance tool 520, a securitization tool 530, and a services tool 540. Additional tools may be added to the suite consistent with the scope and spirit of the disclosure, as is understood by those of ordinary skill in the art.

The omnex exchange 37-2 displays real-time loan program information to the user devices 220 in, e.g., a scrolling ticker format. This data can be provided to the users 210 (via the user devices 220) by state, region or nation. The omnex 37-2 communicates with the RAW 36-4 and can be available to all users 210, which may include trading partners or just wholesale lenders.

The security module 38-1 and the web services module 38-2 manage data flow to and from the HSCN suite 30 to protect the MLM system 100 from viruses, unauthorized access, malware, or the like.

As seen in FIG. 6, the MLM system 100 (shown in FIG. 2) may provide complete visibility into the status of all related tasks for each of the respective users 210, which may include trading partners. Users 210, such as, e.g., regulators, institutional investors, rating agencies, and the like, may access the MLM system 100, to obtain timely, relevant and informative market intelligence. The market intelligence may be reported to the users 210 in real-time, providing forensic and predictive analysis, which is based on substantially real-time data, since the MLM system 100 is configured to continuously monitor market conditions.

As part of the reporting information, the MLM system 100 may produce task-level reports, which may itemize opened and closed requirements necessary for loan fulfillment. The RCU 36-3, for example, may give a user 210 (such as, e.g., a realtor, a borrower, or the like) an ability to simulate a mortgage, or to actually produce a mortgage. The RCU 36-3 may interface with the decision engine (DE) 33-1 to pose questions to the user 210 in, e.g., layman's terms. The answers received from the user 210 may be juxtaposed into requirements by which the DE 33-1 may produce a mortgage solution for a particular borrower. All of the answers received form the user 210 may be treated as variables that may be adjusted based on, for example, the individual preferences of the user 210, which may be provided from the user profile that is associated with the user 210 and/or the particular borrower.

The MLM system 100 is configured to determine the best loan program for a particular borrower based on a variable set of borrower-specific criteria entered by a user 210 (such as, e.g., a loan officer, a realtor, the borrower, or the like). The borrower-specific criteria may be retrieved from a user profile that is associated with the particular borrower. The MLM system 100 may allow a user 210 (such as, e.g., a loan officer) to upload (or download) files (or records) of individual clients (or borrowers) and request mortgage solutions based on controlling variables, including, for example, points, fees, down payment, interest rate, program type, and the like. The user 210 may set the controlling variable(s) by answering questions similar to those posed through the RCU 36-3, discussed earlier.

Through the MLM system 100, RMBs may be dynamically registered with every wholesale lender in, for example, a particular state. A licensing manager may maintain all of the pertinent information (e.g., in a license manager database in the data store 120) that is required by the particular state for licensed retail mortgage bankers, brokers and wholesale lenders to become de facto trading partners. This database may be accessed by the MLM system 100 via the HSCN suite 30 and updated in real-time to insure compliance of all trading partners. Thus, by becoming trading partners on the MLM system 100, RMBs and wholesalers may be able to interact with each other almost immediately. Through the MLM system 100, wholesale lenders may be able to regulate which RMBs they want to offer their programs to. If an RMB falls from favor with a wholesaler, the wholesaler can edit their profile in the MLM system 100 to restrict that particular RMB's ability to use the loan program.

The MLM system 100 is configured to provide industry reporting based on various criteria in real-time, such as, e.g., zip codes, income, property-type, loan programs, and the like. The RAW 36-4 enables both wholesalers and RMB's to produce standard or customized reports on an as-needed basis. All data may be reported in real-time. Wholesale lenders may be registered with every RMB in the state they operate. The licensing manager 33-2 may enable this de facto level of cooperation. The licensing manager 33-2 provides wholesalers with an ability to select and control which RMBs may become and/or remain trading partners of the wholesalers.

The wholesale lender information may be made available to, e.g., every mortgage broker in every state. The MLM system 100 may provide wholesale lender information directly to stakeholders, such as, e.g., realtors, consumers, RMBs, and the like. The wholesale lender information may include loan programs that are available from the participating wholesale lenders. Wholesale lenders may desire to access the MLM system 100, since the system provides a vehicle for the wholesale lenders to market directly to consumers, thereby removing the RMB from the transaction altogether.

As a user 210 of the MLM system 100, a title company may have visibility into all aspects of a process pertinent to gaining a title commitment. For example, information on the status of a loan process may be presented to the title company through the front-end of the integration adapters 36-2. The title company may be provided with information concerning the progress of a loan from approval through underwriting, including information about the particular requirements that may have been fulfilled. Appraisals may be electronically uploaded (or downloaded) by, e.g., an appraiser via the LOS 36-1. This information may be stored in the data stores 120 and made available to the users 210 on the basis of the stored user profiles that are associated with the respective users 210. Initially, a GUI may be provided to the user devices 220 to retrieve information such as, e.g., appraisals.

As a user 210, a seller may also have access to information stored and managed in the MLM system 100. The seller may partner with, e.g., a realtor, FSBO, a lawyer, or the like, to gain access to the status of each trading partner in a particular transaction. The seller may be provided with complete visibility into a P2P transaction. The seller, however, may be prevented from accessing or viewing buyer personal data, or other information that the seller should be prohibited from accessing based on legal, ethical, or other criteria. The seller may be granted modified realtor rights to use the RCU 36-3. Loan reference numbers may be provided to the seller by the buyer, thereby providing an additional layer of security.

As a user 210, a borrower may also have access to the MLM system 100. The borrower may partner with, e.g., a realtor, a retail mortgage broker (RMB), a lawyer (e.g., a lawyer that is acting as a realtor) to gain visibility into status of each trading partner of in a given transaction. The borrower may be provided with complete visibility into P2P transactions. The borrower may be provided with the capability to manage his/her own P2P transactions, including, e.g., a title request, an appraisal, a loan condition, and the like, thereby placing the wholesaler in the traditional role of a retail lender. Where the borrower does not have a representative, the borrower may be provided with direct access to the MLM system 100.

As a user 210, a builder may be provided with the same access rights as a selling realtor in the MLM system 100.

As a user 210, an appraiser may also access the MLM system 100. The appraiser may be provided with the capability to upload (or download) information to the data stores 120 via, e.g., the data repository layer 31. The MLM system 100 may provide an appraiser with an ability to invoice the same appraisal multiple times. The appraisals may be electronically uploaded (or downloaded) by the appraiser or RMB via the LOS 36-1 (shown in FIG. 3). The appraisal information may be stored in the data stores 120 and made available to users 210, such as, e.g., a title company, via the integration adapter 36-2. The appraisals may be stored for a predetermined period of time and then deleted from the data stores 120. The appraisals may be stored for longer periods of time (or indefinitely), beyond, e.g., the typical 6 months to 1 year, since the appraisals can be used to gauge real estate value appreciation within a community, city, state or region. If a user 210 needs to use a particular appraisal more than once (e.g., during re-finance), the user 210 may retrieve the appraisal through the HSCN suite 30 and submit the appraisal to a designated lender. The charge manager 34-5 may manage and pass the charges through to, e.g., the user 210 (e.g., borrower).

As a user 210, an insurer may also access the MLM system 100. The MLM system 100 may store and manage insurance information, such as, e.g., homeowner insurance policies, real estate property insurance policies, and the like. The insurer can upload (or download) insurance information to the MLM system 100 via the integration adapter 36-2. The insurer may offer Insurance products directly to users 210 (e.g., borrowers) based on, e.g., user profiles that are associated with the targeted users 210, which may include consumer preferences and requirements. The insurer may be provided with the ability to dynamically underwrite mortgages in real-time. While the insurer may receive property information, the insurer may be required to provide a homeowner policy for a particular consumer associated with the property information before being provided with the property information. By populating the data stores 120 with insurance information from a plurality of insurers, the users 210 may access the MLM system 100 to obtain market-based insurance pricing that would allow them to access the best point of contact for insurance needs. The insurer may access the MLM system 100, including the data stores 120, via the integration adapter 36-2 to upload (or download) insurance policy information to/from the data stores 1201, as well as to access property information in the MLM system 100.

FIG. 7A shows an example of a process 300 for finding an optimal mortgage solution, according to principles of the disclosure. Referring to FIGS. 3 and 7A, a user 210 logs in into the MLM server 110 via the user device 220 (Step 305). The MLM server 110 verifies the identity of the user 210 (Step 310) and determines the user permissions for the user 210 (Step 315). The MLM server 110 applies the appropriate user permissions and prompts the user 210 to input a borrower profile (Step 320). A determination is made regarding the input type of the borrower profile (Step 325)—i.e., whether the borrower profile has been (or is about to be) input manually or electronically.

If it is determined that the borrower profile has been (or is about to be) input manually (YES at Step 330), then a determination may be made whether to perform a quick search or a full application search to identify a loan solution that best matches the borrower profile (Step 350). If a determination is made to perform a quick search (YES at Step 350), then the user 210 may be prompted to enter search criteria (Step 355), otherwise a WFE is used to receive the mortgage application data (Step 360). After search criteria received from the user 210 (Step 355) or the substantially complete mortgage application is received from the WFE (Step 360), the MLM system 100 may conduct a search of the records in the data stores 120 (shown in FIG. 3) to identify a loan solution that best matches the borrower profile.

If a determination is made that the borrower profile has been input electronically (NO at Step 330), such as, e.g., by downloading or uploading the borrower profile(s) from a local storage device at the user device 220, then a LOS file type may be determined (Step 335) and associated file selection options retrieved from, e.g., the data stores 120 (Step 340). The file selection options may be forwarded to the user device 220 to be displayed on a display of the user device 220 (Step 340). The user 210 may select a borrower 3^{rd} party LOS file from the selection options (Step 345). On the basis of the selected LOS file, the records in the data stores 120 may be searched to identify a matching loan solution (Step 365).

After a matching loan solution is identified for a particular borrower profile (Step 365), the loan solution may be retrieved and forwarded to the user 210 or another user 210, such as, e.g., a lender (Step 375).

Referring to FIG. 4, the decision engine 33-1 may be tasked with identifying an optimal mortgage selection for the user 210, amongst a plurality of rate sheets. Any number of rate sheets may be stored in the MLM system 100, including, e.g., hundreds, thousands, hundreds of thousands, or the like, rate sheets. In identifying the optimal mortgage selection, the user 210 may specify, e.g., a least monthly payment option, a user-specified yield spread premium (YSP), or the like. A YSP is the money or rebate that may be paid to, e.g., a mortgage broker for giving a borrower a higher interest rate on a loan.

The MLM system 100 is capable of determining an optimal loan solution for a given user 210 based on, e.g., the user's user profile. For instance, if the user 210 is a realtor the user 210 may search for a zero-YSP option because of regulation, since this option may provide the least expensive mortgage by reducing closing costs or monthly payments. For this user 210, the preferred comparison may be a calculation of an Annual Percentage Rate (APR) that accounts for YSP and origination fees, amongst other criteria. Origination fees may be included in the computation, since each lender may include a processing cost. An APR describes an interest rate over a period of time (annualized), rather than just a monthly fee/rate, as applied on a mortgage. It is a finance charge expressed as an annual rate.

If the user 210 is an RMB, the user 210 may search for a solution that is optimal for a YSP. The YSP may be calculated based on the amount to be mortgaged and not the sales price of a property. It is a reasonable to expect the interests of certain user-types to be mutually exclusive, such as—e.g., realtors and RMBs.

In rendering a mortgage solution, the MLM system 100 may consider, e.g., static qualifiers, user-subproblem selection, dynamic programming, and category sorting and indexing. Static qualifiers may denote ascribed characteristics of a borrower's profile that can not be modified for the current search. Income, assets, liabilities, and credit scores, for example, may all be variables of a borrower that may remain static for the foreseeable future. Lenders may qualify borrowers based on these variables.

The user-subproblem selection may specifically reference variables that the user 210 may choose, which may then be used to determine the subproblems utilized to render a solution. For example, when a realtor or RMB searches for a mortgage, a “true search” renders all matching programs that are optimally sorted according to an interest rate or a YSP. The true search may include additional variables, such as, for example, property type (e.g., single family, town house, condo, co-op, multi-tenant, commercial, or the like), occupancy (e.g., owner occupied (O/O), non-owner occupied (N/O/O)), and multi-tenancy (e.g., 2 units, 3-4 units, or the like). By indicating his/her preference, a borrower selects a set of subproblems (from the universe of subproblems available in the MLM system 100) that may be used to render the optimal solution for the borrower's problem—e.g., identifying the least costly mortgage via a sorted APR list.

Category sorting and indexing enables the MLM system 100 to recursively define a value of an optimal solution to each category and store an index for faster mortgage solution processing times. When lenders, for example, build their rate sheets in the MLM system 100, the system captures their categories and pricing adjustments. In other words, if a lender offers N/O/O underwriting, they will list their pricing adjustments for the category labeled “N/O/O” on the rate sheet. If a borrower seeks to qualify for a mortgage as an N/O/O borrower, all lenders that support N/O/O will have to be identified and then compared to one another. The system recursively sorts each category—e.g., N/O/O, interest-only (I/O), multi-tenancy, loan-to-value (LTV), and to like—that a lender supports. The recursive sorting of the categories may be done in substantially real-time—i.e., a fraction of a second after the lender submits its rate sheet.

Although some steps have been captured via user-subproblem selection, and subproblem optimization, dynamic programming may also require rendering the value of an optimal solution in a bottom-up fashion. Said another way, once a set of subproblems are identified to yield an optimal solution for “select best mortgage,” the categories may be merged to find the optimal solution.

FIG. 7B shows an example of a process 3650 for creating an optimal mortgage solution, according to the principles of the disclosure. Initially, a lender may be identified from the universe of available lenders in the MLM system 100 (Step 3651). All (or substantially all) of the mortgage solutions for the identified lender may be retrieved, sorted and indexed (Step 3652). A determination may be made whether the entire (or substantially the entire) universe of lenders has been identified and all of the associated mortgage solutions sorted and indexed (Step 3653). If it is determined that all of the lenders have not been identified (NO at Step 3654), then the process may return to determine the next lender in the universe of lenders (Step 3651).

If it is determined that all of the lenders in the universe of available lenders have been identified, and that all of the associated mortgage solutions have been sorted and indexed (YES at Step 3654), then all of the mortgage solutions for all of the lenders may be merged, sorted and indexed (Step 3655). A user profile for a particular borrower (or consumer) may be compared to all of the mortgage solutions (Step 3656). In this regard, user-selected criteria in the user profile, such as, e.g., Time-to-Close (TTC). Percent-to-Close (PTC), and the like, may be compared to all of the mortgage solutions to identify an optimal mortgage solution for the particular user profile. The mortgage solution determined to best match the user profile may be determined to be the optimal mortgage solution for the particular user profile (Step 3657). The determined optimal mortgage solution may then be sent to the user (Step 3658). The optimal mortgage solution may be sent to, e.g., the user device 220 (shown in FIG. 3) via the communication link.

For users 210 (e.g., mortgagees) that wish to modify existing loans to avoid default or to ameliorate a potential loan default situation, an optimal loan modification may be carried out by the MLM system 100 for these users. The MLM system 100 may employ one or more of the following strategies: principal forbearance; interest rate reduction; term extension; or debt-to-income (DTI) assignment.

For example, if an original loan is an ARM-type loan, it may be modified to, e.g., a 30-year fixed rate loan at a market interest rate based on the following relationship.

$$A = P \frac{{i ( 1 + i )}^{n}}{{i ( 1 + i )}^{n} - 1} = \frac{P * i}{1 - {i ( 1 + i )}^{- n}}$$

where A is a periodic payment amount; P is an amount of principal, net of initial payments, meaning “subtract any down-payments”; i is the going market interest rate; and n is the total number of payments (e.g., for a 30-year loan, n would be 360 months). A DTI may be calculated with a new P+i. If the DTI is set to, e.g., less than or equal to a predetermined threshold TH (e.g., 32%), a servicer may verify new payment terms with the investor and the lender. The modified loan may be proposed to the user 210 (e.g., mortgagee) in response to a request by the user 210, or at the request of, e.g., the mortgagor.

If the DTI is greater than the predetermined threshold TH (e.g., 32%), the MLM system 100 may implant the following reduction formula:

d″=I*TH−d′

where d is the debt amount, D is the debt total, d′ is the monthly debt, d″ is the new loan modification, e is the home equity (monthly), and I is the monthly income. The MLM system 100 may determine which D can be paid off with e in order to get a DTI that is less than or equal to the predetermined threshold TH. For example, if d′=6,000 and I=10,000, then DTI=60%. In this case, the decision engine 33-1 may identify which D could be paid off with e to get the DTI to equal the predetermined threshold TH (e.g., 32%). For the purposed of this example, if we assume e=1500, then d′ may only be reduced to 4500, but d′ needs to be 3200. Thus, the decision engine 33-1 needs to adjust another −1300 from d′.

If the DTI remains greater than the predetermined threshold TH (e.g., 32%), the decision engine 33-1 may implement the following relationship.

$${A}_{n + 1}^{′} = \frac{P * i}{1 - {i ( 1 + i )}^{- n}}$$

where A′ₙ₊₁ is a payment in progressive assignment periodic payment amount.

FIG. 7C shows an example of a process 400 for finding an optimal mortgage solution, according to the principles of the disclosure. Initially, search criteria may be received from a user 210 (consumer) for a mortgage (Step 405). The search criteria may be received in a session established between the user device 220 and the MLM system 100. In this regard, a loan officer or realtor can also enter consumer information and perform a search as proxy. A realtor may invite a consumer to use the MLM system 100 and monitor the consumer's progress in the transaction. On the basis of the search criteria, the MLM system 100 may search the entire universe of lender loan programs available in the data store 120 (Step 410). Matching the user search criteria to all available lender loan programs, one or more best matching loan programs may be identified (Step 415). The matching loan program(s) may be presented to the user 210 (Step 420). A loan program may be selected by the user 210 and the selection received by the MLM system 100 (Step 425). Based on the received selection, the user 210 may be provided with a loan application (Step 430). After the user 210 completes the loan application, the completed (or partially completed) loan application may be received and a user profile created for the user 210 (Step 435). The user profile, including the completed (or partially completed) loan application may be stored in, e.g., the data store 120. In addition to the loan application, the user 210 may submit supporting documentation for selected loan program. The MLM system 100 manages the received documentation to support the loan application, enables verification of the user profile, and renders the user profile searchable by stakeholders (e.g., lenders, investment bankers, investors, underwriters, or the like). In this regard, a buyer/seller-side realtor can monitor the progress of a mortgage application. The seller-side realtor may access the system to view the progress of an impending sale and/or an offer to buy a property that is listed.

FIG. 7D shows an example of a process 600 for finding one or more matching user profiles to one or more lender defined criteria. Initially, the lender criteria may be received in real-time (e.g., via the user device 220) or as part of a lender profile, which may be retrieved from the data store 120 (Step 445). Based on the lender criteria, a search may be conducted of all user profiles in the data store 120 (Step 450). The best matching user profiles may be identified (Step 455) and presented to the lender (Step 460). A selection of one or more of the matching user profiles by the lender may be received (Step 465). Should the lender elect to run another search using different search criteria (YES at Step 470), then the new search criteria may be received and the process repeated. If the lender elects to contact some or all of the matching user profiles (NO at Step 470), then a message may be sent to those users associated with the elected matching user profiles (Step 475). The message may include, for example, a loan application, a financial product, a service, or the like. The elected matching user profiles and the lender profile may be updated to include information about the message(s) sent to the users, including, e.g., any application(s) sent to the users, replies from the users, and the like (Step 480).

The MLM system 100 may further manage all workflow required to underwrite a mortgage for a particular user profile, including, e.g., checklists, conditions to close, communication messaging between all interested parties, insurance riders, title commitments, sales contracts, appraisals, and the like.

The MLM system 100 may support the closing process by storing and managing all closing documents and records with each associated user profile.

The MLM system 100 may support the pooling of loans process, as well as the selling of the mortgage pools (or parts thereof) by storing and managing the user profiles, including all information related to entire mortgage lifecycles in the data store 120 in a format that allows stakeholders (such as, e.g., investment bankers) to create fractionalized mortgages. The MLM system 100 enables these stakeholders to associate a mortgage pool with an SPV or individual institutional investors.

The MLM system 100 may support the monitoring/assessing of mortgage statuses or histories by storing and managing the histories surrounding each mortgage transaction processed or stored in the system. Stakeholders (e.g., investors, bankers, or the like) may mine the data stores 120 to identify user profiles and mortgages for refinancing, other loan programs offers, financial products, and the like.

The MLM system 100 further enables stakeholders to analyze user/market/application data. Users 210 (e.g., lenders, third party providers of ancillary services/products, or the like) may search and examine user profiles for patterns of interest.

The MLM system 100 enables users 210 to create markets based on existing user profile data. Marketing to users who are consumers is not limited to mortgages. Other providers of services may mine the data store 120 for user profiles of consumers to whom they want to market their products and services. The system enables other users to place additional product offerings for consumers by allowing, e.g., a third party to mine the stored data and build a market. The MLM system 100 also may allow users 210 (e.g., lenders, and the like) to see placement of their markets within existing user profiles, as well as to publish new product offerings. The users 210 may revise and repeat market definitions in viewing the placement of their market within the existing user profiles.

A computer readable medium may be provided that includes a computer program tangibly embodied therein, or thereon. The computer readable medium may comprise a code section or code segment for each of the steps in FIGS. 7A, 7B, 7C, and/or 7D, as well as the other processes described in this disclosure. When executed on, e.g., a computer or the MLM server 110, the computer or the MLM 100 may cause each of the steps in FIGS. 7A, 78, 7C and/or 7D to be carried out.

FIG. 8 shows an example of a universal residential loan application 800 for a particular loan identification number (ID) that may be presented to a user 210 (shown in FIG. 3) to complete. Referring to FIGS. 3 and 7A, for example, the user device 220 may be provided with the application 800 at Step 360 as a template to receive the user 210 mortgage application data.

FIG. 9 shows an example of a loan program results display 900 that may be presented to a user 210 after the process 300 has been carried out and no matches are found for the criteria in the user profile associated with the user 210. The user 210 is alerted that the user profile will be stored in the MLM system 100 and that the user 210 will be later notified, should a matching loan program be identified.

FIG. 10 shows an example of a loan program results display 1000 that is associated with the loan ID of the loan 800 (shown in FIG. 8), which may be presented to the user 210. The display 1000 may provide a plurality of fields containing information such as, e.g., program type, interest rate, term, lender, monthly payment, debt/income ratio, and the like.

FIG. 11 shows an example of a loan summary information display 1100 that is associated with the loan ID for the loan application 800, which may be presented to the user 210.

FIG. 12 shows an example of a confirmation page display 1200 that is associated with the loan ID for the loan application 800, which may be presented to the user 210.

FIG. 13 shows an example of a wholesale alert display 1300 that is associated with the loan ID for the loan application 800, which may be presented to another user 210, who may be a wholesale lender.

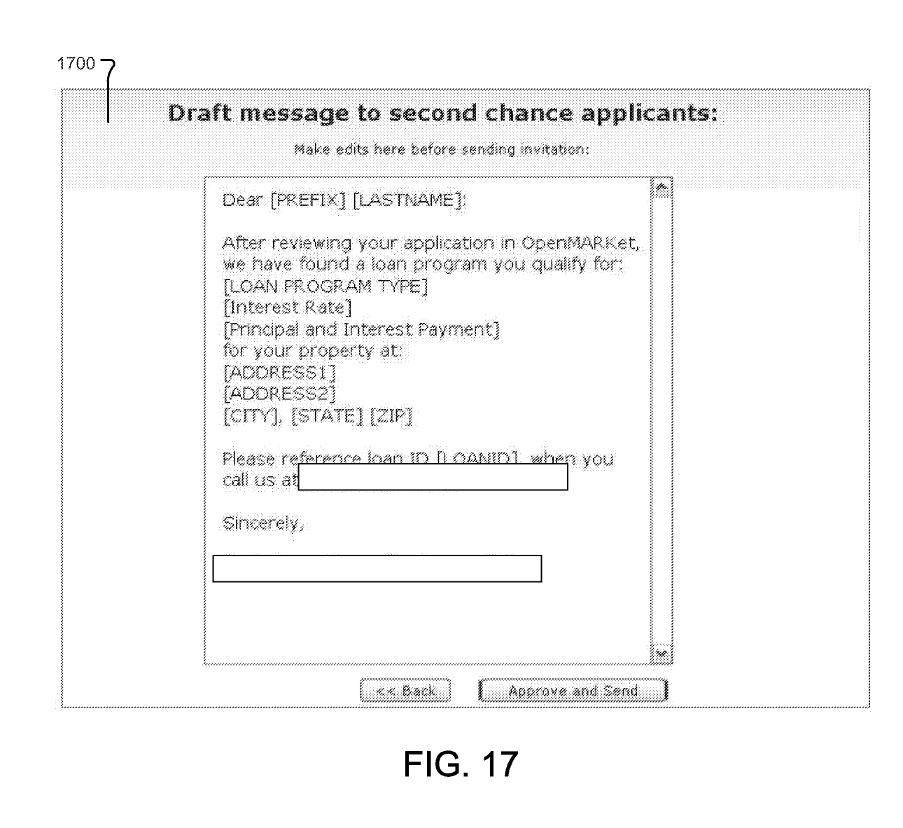

FIGS. 14-17 show examples of wholesaler workspace displays 1400-1700, respectively, that may be presented to a user 210 who is, e.g., a wholesale lender. The wholesaler workspace display may provide information such as, e.g., loans that were accepted, recently received loan applications, pool of rejections, state loan application failures, and the like. The state loan application failures may include, for example loan IDs, zip codes, income thresholds, property types, counties, and the like. FIG. 17 in particular shows an example of a message display 1700 of a message that a wholesale lender may be presented for all of the mortgage applications that would qualify for the lender's mortgage product out of an entire pool of mortgage applications after the mortgage lender has adjusted an income requirement by, e.g., 3%.

FIGS. 18-23 show examples of a federal oversight stakeholder workspace displays 1800-2300, respectively, that may be presented to a user 210 who is. e.g., an investigator, an auditor, a regulator, or the like.

FIGS. 24-27 show examples of a state oversight stakeholder workspace displays 2400-2700, respectively, that may be presented to a user 210 who is, e.g., an investigator, an auditor, a regulator, or the like.

FIGS. 28-32 show examples of an investor workspace displays 2800-3200 that may be presented to a user 210 who is, e.g., an investor, an institutional investor, an investment banker, a securitization agent, or the like.

Referring to FIG. 3, a user 210 may provide the stakeholders with targeted information, such as, for example, but not limited to all (or part) of the available loan products, all (or part) of the borrower information associated with borrowers applying for a loan, all (or part) of the appraisals captured and archived for a property, state/federal regulators and/or governance, real-time intelligence utilizing forensic and predictive analysis, automated loan program adjustments, and the like. The stakeholders may access the information on the MLM system 100 through, for example, a web portal, passive updates, a mobile interface application, or the like.

The MLM system 100 creates unprecedented transparency in mortgage markets. The system includes a fully integrated, web-based exchange platform on, for example, a server 110 that provides lenders, buyers, securitization participants and regulators all access to real-time reporting of housing market data. The “users” may include, for example, borrowers, credit agencies, lenders, retail banks, realtors, mortgage brokers/bankers, mortgage servicing companies, title agencies, insurance providers, appraisers, inspectors, investment banks, ratings agencies (for example, S&P, Moody's, Fitch, etc.), mortgage-backed Securities Insurers, mortgage-backed securities investors, any firm interested in consumer-related behavior, and the like.

System technology stores and analyzes data on consumer profiles, approved and denied mortgage applications, appraisals and vendors, and any services they provide to any mortgage application. The data may be stored in the data stores 120. The data can then be used by regulators for forensic and predictive analysis that will support their ability to better manage fraud and predatory lending practices or any other aspect of the mortgage lending process. It will also enable better purchasing decision-making for home buyers. The system technology has the ability to drive system-wide accountability. The system 100 may be interconnected via a plurality of communication links and a network 200.

The MLM system 100 provides a mechanism for users (such as, e.g., lenders) to publish their wholesale products directly to consumers in real-time. For example, the MLM system 100 offers lenders a mechanism to place their products directly to MLM system databases of active, available products that may be presented to consumers. The MLM system 100 allows lenders to define how and what products may be presented to the consumers. Thus, the MLM system 100 allows lenders (or their market makers) to dynamically create markets and adjustments, including the dimensions of data inspection and mining, market creation, and template definitions.

The MLM system 100 enables a lender to examine a database of borrowers. In addition to the lender's own borrowers, the database may include aggregate and anonymous information about other borrowers who have not applied for a loan that the lender offers or has offered. This data may be mined for patterns in order to identify markets to pursue and the appropriate pricing to win those markets. As the data includes past and current loan applicants, it gives the lender visibility into the datasets representing a broad range of potential customers—for example, borrowers who purchased adjustable rate products and may want to refinance; borrowers who are actively looking for a loan but have not yet decided to apply for one; and applicants who were recently rejected for a loan but may be acceptable borrower with modified terms.

The MLM system 100 also enables a lender to use the results of examination/data mining to directly create markets or adjustments. The lender may also manually specify the definitions of markets or adjustments in the MLM system 100. The lender may save templates or baselines of markets and adjustments and create new markets or adjustments based on these templates or baselines, with modifications. A market or adjustment can be offered in real time by designating it as active in the MLM system 100.

The makers of secondary markets may use the MLM system 100 to create spot (dynamic) markets and adjustments. The creation of a market allows a secondary market maker to directly offer loans to consumers, allowing them to create portfolios of loans that precisely match the profiles desired for securitization products. If these loans are funded by the secondary market makers, this process effectively creates a new channel for them to obtain loans without an intermediating lender. If the secondary market maker can originate and process the loans through the MLM system 100, they may eliminate a broker intermediary. The MLM system 100 may function as a service that allows the secondary market makers to go directly to consumers.

The MLM system 100 supports the creation of spot markets and adjustments based on a set of variables (and their combinations). The MLM system 100 minimizes distribution channels by publishing directly to consumers. The MLM system 100 is configured to allow stored information to be analyzed and used to define markets and adjustments, thereby allowing a lender to create products that target narrow or specialized markets. The MLM system 100 also allows the lender to cross-reference additional data when viewing potential customers or creating markets. This additional data can be supplemental demographic, economic, or market information that would not be part of a mortgage application, such as, e.g., crime rates for zip codes, average duration of residency for condo buyers with specific income ranges, and the like, or additional borrower-specific information, such as, e.g., the number of children, the make of car, and the like. Supplemental data can be provided by the MLM system 100 or by a user, such as, e.g., a lender. The MLM system 100 optionally may provide users (e.g., lenders) with access to such additional information for a fee, including, e.g., mechanisms inside of the system to cross-reference supplemental data with applicant information to define markets or adjustments.

The MLM system 100 provides users (such as, e.g., securitizers) to examine the data of loans that closed, selecting exactly the loans they wish to purchase to create their products. Securitizers' tools for data examination/mining are similar to the tools that are used by lenders to create spot markets. The system allows lenders to create a marketplace for loans they have made—in additional to reselling loans through traditional channels, lenders can offer loans to the secondary market via the MLM system 100. The system allows securitizers to create a demand market for loans they wish to purchase—in addition to soliciting loans through traditional channels, securitizers can place a bid for loans that match their desired characteristics via the MLM system 100.

The MLM system 100 may further extend the visibility into mortgage pools to other users, such as, e.g., investment bankers and institutional buyers. These users can: examine the borrower details that underlie tranches of mortgages and their performance; examine and mine the underlying loan details in the securities they purchase; use tools similar to those provided to lenders to analyze and mine data; be more selective about the mortgage products they purchase; and purchase fractionalized products.

The MLM system 100 supports a full mortgage lifecycle from mortgage origination to purchase of mortgage based securities or derivatives. The deep visibility into mortgage details afforded by the system processes is retained throughout this lifecycle. As a result, the system offers users a means of purchasing fractions of mortgages and creating securities or derivatives based on the fractions. Not only is full, on-line, mineable traceability maintained from a security to the constituent mortgages, but fractions of those individual mortgages can be incorporated into different securities or derivatives. For example, secondary market purchasers could buy a percentage of each individual mortgage that matches their criteria, rather than a number of whole mortgages, which allows distribution of risk across a larger pool of mortgages

In using the MLM system 100, consumer mortgages may be subsidized by selling views and uses of applicant data, and in particular by allowing third parties to target markets defined using the rich data discussed above. The combination of ad revenue, customer access fees and finder fees (sales commissions) may partially (or fully) cover the mortgage procurement fees, allowing the MLM system 100 to offer mortgages at low or no cost. These low/no cost mortgages may be a very desirable service to mortgage consumers and may lead to a steady influx of new customer data to perpetuate the model.

Although the disclosure has been provided with reference to several embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather, the disclosure extends to all functionally equivalent structures, methods, and uses such as are within the scope of the appended claims.

In accordance with various embodiments of the present disclosure, the methods described herein are intended for operation as software programs running on a computer. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

Although the present specification describes components and functions implemented in the embodiments with reference to particular standards and protocols, the disclosure is not limited to such standards and protocols. Accordingly, replacement standards and protocols having the same functions are considered equivalent.

While the disclosure has been described in terms of exemplary embodiments, those skilled in the art will recognize that the disclosure can be practiced with modifications in the spirit and scope of the appended claims. These examples given above are merely illustrative and are not meant to be an exhaustive list of all possible designs, embodiments, applications or modifications of the disclosure.

What is claimed is:

1. A method for managing a mortgage lifecycle, the method comprising:
receiving user search criteria from a user for a loan program;
searching all loan programs stored in a data store;
determining an optimal loan program based on the user search criteria;
presenting a loan application for the optimal loan program to the user; and
creating a user profile based on the user search criteria and the loan application.

2. The method of claim 1, further comprising:
storing the user profile in the data store; and
facilitating management of a full lifecycle of a loan associated with the optimal loan program, including substantially all origination activities, substantially all securitization activities, and substantially all closing activities.

3. The method of claim 1, wherein the user search criteria is received from a loan officer or a realtor.

4. The method of claim 1, further comprising:
receiving supporting documentation from the user for the optimal loan program; and
rendering a mortgage that is associated with the loan application available to another user for examination.

5. The method of claim 4, further comprising:
managing the supporting documentation to support the loan application for the optimal loan program.

6. The method of claim 1, further comprising:
rendering the user profile searchable by another user; and
presenting all information related to the user profile in the data store to said another user.

7. The method of claim 1, wherein the user search criteria comprises an interest rate, a loan term, a loan amount, or a loan type, the method further comprising:
providing post-closing state monitoring information, monitoring/assessing status information or mortgage history information to another user; and
facilitating market making for said another user for mortgages, including: mortgage pooling, mortgage securitization, or fractionalization of a mortgage note.

8. A mortgage lifecycle management system, comprising:
a loan origination system that is configured to receive a plurality of lender profiles, each of which includes one or more loan programs;
a data store communicatively coupled with the loan origination system, the data store being configured to store the plurality of lender profiles; and
a decision engine that is adapted to communicate with the data store to access the plurality of lender profiles,
wherein the decision engine is further adapted to determine an optimal loan program on a basis of a user search criteria received from a user and the plurality of lender profiles.

9. The system of claim 8, further comprising:
a communicator adapted to send a loan application to the user for the optimal loan program;
a manager that facilitates management of a full lifecycle of a loan associated with the optimal loan program, including substantially all origination activities, substantially all securitization activities, and substantially all closing activities.

10. The system of claim 9, wherein the decision engine is further adapted to create a user profile based on the user search criteria and the loan application, the system further comprising:
a manager that renders a mortgage that is associated with the loan application available to another user for examination.

11. The system of claim 8, wherein the decision engine is further adapted to index the plurality of loan programs.

12. The system of claim 10, wherein the decision engine is further adapted to store the user profile in the data store, and wherein the manager presents all information related to the user profile in the data store to said another user.

13. The system of claim 8, further comprising:
a communicator that is adapted to receive supporting documentation from the user for the optimal loan program.

14. The system of claim 13, further comprising:
a manager adapted to manage the supporting documentation to support the loan application for the optimal loan program, including all closing documents and records associated with the loan application.

15. The system of claim 13, further comprising:
a workflow manager adapted to manage at least one of a checklist, a condition to close, a communication message, an insurance rider, a title commitment, a sales contract, and an appraisal.

16. The system of claim 8, wherein the user search criteria comprises an interest rate, a loan term, a loan amount, or a loan type, the system further comprising:
a manager that provides post-closing state monitoring information, monitoring/assessing status information or mortgage history information to another user,
wherein said manager is further configured to facilitate market making for said another user for mortgages, including: mortgage pooling, mortgage securitization, or fractionalization of a mortgage note.

17. A computer readable medium having a tangibly embodied computer program thereon, which when executed on a computer cause the computer to carry out a method comprising:
receiving user search criteria from a user for a loan program;
searching all loan programs stored in a data store;
determining an optimal loan program based on the user search criteria;
presenting a loan application for the optimal loan program to the user; and
creating a user profile based on the user search criteria and the loan application.

18. The computer readable medium of claim 17, comprising:
a documentation receiving code section to receive supporting documentation from the user for the optimal loan program.

19. The computer readable medium of claim 17, comprising:
a supporting documentation managing code section manage supporting documentation to support a loan application for the optimal loan program.

20. The computer readable medium of claim 17, comprising:
a comparing code section to compare the user search criteria to all of the lender profiles; and
a sending code section to send a loan application for the optimal loan program to a user device.
